(19) United States
(12) Patent Application Publication
(10) Pub. No.: US 2024/0380717 A1
(43) Pub. Date: Nov. 14, 2024

(54) KIWI CHAT

(71) Applicant: KiwiChat, Inc., North Miami, FL (US)

(72) Inventors: Ryan J. SHAPIRO, Miami, FL (US); Shiva MANNE, Anjuna Bardez (IN); Shai ZIV, Tenafly, NJ (US); Yaakov KATZ, Miami, FL (US)

(21) Appl. No.: 18/630,932

(22) Filed: Apr. 9, 2024

Related U.S. Application Data
(63) Continuation of application No. 17/731,210, filed on Apr. 27, 2022, now abandoned.
(60) Provisional application No. 63/180,632, filed on Apr. 27, 2021.

(51) Int. Cl. H04L 51/212; G06F 3/0484; G06F 16/435; G06F 40/205; G06F 40/289; G06F 40/30; H04L 51/046; H04L 51/063; H04L 51/10

(52) U.S. Cl. CPC H04L 51/212; G06F 3/0484; G06F 16/435; G06F 40/205; G06F 40/289; G06F 40/30; H04L 51/046; H04L 51/063; H04L 51/10

(57) ABSTRACT

Presented herein is a substantially instant messaging system for one or more of generating, receiving, evaluating, and transmitting communications from a first party to a second party. The system includes a moderation platform for autonomously reviewing communications for prohibited content, whereby the content and context of one or more messages of a communication are reviewed and assessed for containing forbidden subject matter. Messages having a determined probability of containing prohibited content will be sequestered and not be transmitted.

### CROSS REFERENCE TO RELATED APPLICATION

The present application is a continuation of U.S. patent application Ser. No. 17/731,210, filed Apr. 27, 2022, entitled “KIWI CHAT,” which claims the benefit of U.S. Provisional Patent Application No. 63/180,632, filed Apr. 27, 2021, entitled “KIWI CHAT”, the disclosures of which are incorporated herein by reference in their entirety.

### FIELD OF THE INVENTION

The present disclosure is directed to a communications moderation system by which communications and their content can be autonomously reviewed, assessed, evaluated, and if need be sequestered prior to communication delivery. In various embodiments, a moderated, substantially instantaneous messaging system is provided.

### BACKGROUND

The following description of the background of the invention is provided simply as an aid in understanding the invention and is not admitted to describe or constitute prior art to the invention.

Incarceration for those who abridge the law is an unfortunate necessity for society. There are many reasons by which someone may break the law, and in this regard, many law breakers do not make a profession out of criminality. However, recidivism becomes problematic when the only community an inmate has is with those with whom they are incarcerated. In these regards, creating the opportunity for an incarcerated individual to stay connected to a larger community with more positive social values is an important aspect of rehabilitation. A problem arises, nevertheless, with regard to how to keep those who have been incarcerated connected to others in other communities outside of the prison environment.

Particularly, historically, a primary way to communicate with someone who was incarcerated was with a pen and paper. Those seeking to communicate with a prisoner was to write them a letter. Yet, once written, it would typically take a week for a letter to arrive to the correctional facility, another week for the letter to be reviewed by the correctional staff, and then a further week or two for a response to be written by the inmate, to be reviewed, and sent. This caused a substantial amount of delay in the communication process, led to extensive disconnections, disrupted relationships, caused feelings of isolation and loneliness, and increased frustration. Often times these feelings of isolation and frustration were not handled appropriately by the staff of the correctional facility, which further caused increased irritation and negative sentimentality within the prison community.

One solution to this problem was the use of an email exchange server that was provided as a means of allowing electronic communications for those who had been incarcerated to communicate with others, such as by providing an electronic interface for an inmate to log in to a website, such as at an email kiosk, allowing them to look up potential communication recipients, and then allowing them to draft and send an email to another inmate or other recipient. However, the use of such email exchanges suffers from many of the same problems as with traditional letter exchanges. Specifically, once the email was sent, it still needed to be sequestered, and still needed to wait in a queue to be reviewed by a Department of Corrections staff member to review the email and decide whether or not to allow the email to be transmitted. Once approved for transmission, the email was then printed and hand delivered to the inmate. In many of these implementations, the email exchange services were embodied in a kiosk, whereby the entire process of transmission, review, and printing was all performed electronically at the kiosk, such as for back-and-forth email exchanges.

In some instances, the review process has been attempted to be automated, such as by including a dictionary filter, whereby emails can be reviewed to determine if they contain certain known prohibited words, and if so, these emails can be flagged and be reviewed and/or sequestered and be prohibited from being transmitted. A critical problem with such dictionary filters is that they need to account for mis-spellings, phonetic spelling, use of synonyms, ironic use of antonyms, and the like, and even when the words to be flagged are appropriately identified, there is still the fact that many words can have a plurality of definitions or meanings, such as where one definition may be negative, but another definition of the word may be positive. In these situations, a word dictionary is not capable of determining if a given used word has a positive or negative definition.

For instance, in such a situation, the department of corrections employing such a word flag dictionary, has to choose a word they want on their flag list, for example “hit” or “kill.” However, even though, on their face, these words may seem to be clear threats, there are contexts wherein the words are actually used in a positive manner, such as: “I'm going to “hit” it big with this lottery ticket,” versus “I'm going to place a “hit” on you.” In the first context the word “hit” has a positive connotation, e.g., winning the lottery, whereas in the second context, the word “hit” has a negative connotation of imminent threat. Likewise, consider the following contexts in these two scenarios: “I'm going to “kill” you in the game today,” versus “I'm going to “kill” you when you sleep tonight.” In the first context, although the word “kill” has a negative connotation, e.g., beating an opponent, it is a socially acceptable manner by which to communicate, e.g., trash-talk, with opponents in a competition. However, in the second context, the word “kill” is definitely meant as an imminent threat.

Nevertheless, in either instance, when the words “hit” or “kill” or other such words in a message being reviewed are run through the dictionary filter, the messages immediately get flagged regardless of the context within which the words are used. Hence, whenever an email says, “Hey, hit me back later,” or “My back is killing me,” those emails get flagged and likely get sequestered, which when read in their contexts shows they should not be flagged or sequestered. Such filters stop a significant amount of communications, e.g., emails, that should never be stopped.

Another issue arises in a situation where none of the words in a message are prohibited, but the context is clearly threatening, such as where a communication includes a message such as “If you don't pay me tonight, tomorrow you sleep with the fishes!” In this instance, the communication is likely to be transmitted, which by its context is clearly threatening and should not be sent, but it is only by understanding the context does the meaning become clear as a threat. So, problems with the existing systems are that they stop a ton of messages that should never have been stopped, e.g., false positives, and transmit too many messages that should be stopped, which do not contain a single word or phrase that could be added on a dictionary list, but nevertheless contain threatening or otherwise prohibited subject matter. The end result is poor security and frustrated customers, e.g., inmates, because so many innocent messages get stopped and threatening messages get sent. These problems are what the current system proposes to correct.

A similar thing occurs with photos, where currently every photo or video or other attachment is sequestered for human review, regardless of its content. There is simply no system currently available that can look at photos, or videos, or the like, and can determine whether they include prohibited or otherwise forbidden content, such as nudity, weapons, drugs, drug paraphernalia, and the like. This type of human review is expensive and time consuming, and largely unnecessary as the majority of image content contain no discernable violations.

Accordingly, without understanding the contexts in which words are used, a flag dictionary filter, used in isolation, will either lead to too many false positives or false negatives, thereby failing to achieve its objectives. In such instances, it has often been found that 90% of communications sequestered by a dictionary filter for containing prohibited words, were false positives, such that when understood in light of the actual context, as determined by a human reviewer, the communications did not in fact contain prohibited content. Such false positives result in unnecessary delays in communication delivery, frustration within the overall community, and undue burdensomeness on the staff of the correctional facility charged with reviewing the flagged messages. Thus, flag dictionaries tend to be poor moderation tools for assessing threats and/or threat levels inherent to a message, and thus, are not readily suitable as a security device for assessing communication content and/or context.

However, although automated flag dictionary processes are useful, their usefulness is very limited in that inmates and those with whom they correspond are constantly trying to circumvent the word filters, such as by mis-spelling words, using phonetics, or codes where one word is used to mean another word, and the archaic flag dictionary process still often required sequestration and human review, thereby not solving the problems with delays. Further, although a word dictionary is useful for identifying prohibited words, it cannot be used to identify prohibited content in images. Consequently, every picture or attachment that is sent through an e-mail has to be manually viewed, reviewed, and assessed, which is a very challenging and cumbersome task.

So, what is needed is a substantially real-time, instant messaging system whereby a platform is provided within which messages can be drafted, reviewed, evaluated, sent, and/or sequestered, such as autonomously and substantially at real-time. In order for this process to be effectuated, an analytics system, such as including a finely tuned Artificial Intelligence (AI) module, needs to be formulated and structured to both recognize prohibited words, phrases, catch-phrases, as well as the contexts in sentence fragments, sentences, and paragraphs. Based on specific training, the AI module needs to be configured to not only recognize problematic content, but also problematic contexts, whereby messages to be transmitted may be immediately and autonomously reviewed, both while being written and/or being sent, the context of the messages may be determined, and a threat level may be assessed. And based on that assessment, a threat level may be determined, and a remedial action may be developed and taken. Such an analytics system when fully implemented provides for substantially real-time, e.g., instant, messaging.

Accordingly, provided herein is a substantially real-time communications platform that solves the problems with the aforementioned communications architectures, such as by allowing for both content, such as a word or phoneme, etc., and context-based review, both for written messages and attachments, such as including images and video files, which is substantially contemporaneous with the drafting and/or transmitting of the communication. As indicated, the substantially real-time communications platform presented herein provides an analytics system that includes one or more processing engines that have been precisely configured, such as through the running of hundreds to thousands, to hundreds of thousands, to millions of models so as to be able to more efficiently recognize both words and contexts of communications seeking to be transmitted. In a manner such as this, threatening and/or prohibited content, which may be prohibited based on its content, regardless of content, as well as material that is threatening and/or prohibited based on its context, may be identified, and appropriate actions can be taken by the system in response thereto.

In various instances, the analytics system may include one or more content filters, such as word, word-fragment, and/or phoneme filters, as well as one or more context filters, which may be tuned to one or more word groups, sentence fragments, sentences, and the like. For instance, one content filter, e.g., pre-filter, may be a flag dictionary, that is used to identify words and word fragments, which on their face are threatening and/or prohibited, such as being directed to threats, violence, weapons, drugs, paraphernalia, and the like. In other instances, one or more context filters, e.g., pre-filters, may be included so as to understand if a communication contains prohibited content based on the structure, content, and context of sentence fragments, sentences, and sentence groupings. Such context filters may include one or more classification and/or category filters. In various embodiments, the analytics system may include one or more sentiment analysis engines for determining one or more sentiments being conveyed within a message being drafted. The goal of the technologies described herein is to solve these and other such problems.

### SUMMARY

In one aspect, provided herein is a system for one or more of generating, receiving, evaluating, and transmitting communications from a first party to a second party. In various embodiments, a substantially instant messaging system is provided, wherein the system includes a moderation platform for reviewing messages for prohibited content, whereby the content and context of one or more messages of a communication are reviewed and assessed for containing forbidden subject matter. In this regard, in a first instance, one or more client computing devices are provided, such as a first client computing device having a display coupled therewith and including a communications module for generating and transmitting a communication via an associated network connection.

Particularly, the client computing device may include one or more processors that are configured for running client applications that are associated therewith, such as a client application for producing a client dashboard having a graphical user interface that includes an input interface through which a raw communication may be generated and transmitted via a communications module of the client computing device. A client computing device of the disclosure may be embodied by any computing device by which computer implemented instructions may be processed and executed, such as in the form of a desktop or laptop computer, a mobile computing device, such as a smart phone or tablet computer, a smart watch, and the like.

The system may further include a database, such as for storing computer implemented instructions, as well as one or more searchable libraries, for instance, where each library may include data pertaining to one or more keywords or images that have been determined to be of actual concern to a moderating authority, such as a correctional facility, from which a set of initial models may be generated as to what constitutes prohibited content. The data pertaining to one or more keywords or images that have been determined to be of actual concern may be any data that is related to concepts that any given correctional facility determines to be potentially harmful to their population. As indicated, in various embodiments, the data pertaining to the one or more keywords or images may be associated with one or more models by which the context of one or more words in a sentence, or one or more sentences in a paragraph, may be determined. In certain embodiments, each of the one or more actual concerns may have a first relative weighting associated with it, such as where the weight may pertain to one or all of a category, classification, or type of concern to the moderating authority and a level of concern.

The system may additionally include a server system for receiving the raw communication from the first client computing device and for evaluating the raw communication against the data pertaining to one or more keywords or images of actual concern from at least one of the one or more libraries, so as to determine the likelihood that the raw communication contains prohibited content or can be transmitted to a recipient without harm. In certain instances, the data pertaining to one or more keywords or images of actual concern may be embodied by a model by which contexts of one or more messages within a communication can be determined. Consequently, a raw communication can be evaluated against one or more generated contextual-based models.

In this regard, the evaluation may be performed by a suitably configured analytics module of the server, whereby the analytics module may be configured for reviewing a communication and determining its meaning, such as by determining the meaning of each word individually, and in relation to one another, and thereby determining the context of the words in the message, and the communication as a whole. In certain instances, the evaluating may include comparing the words in sentences in combination to one another to one or more models that have been previously determined to be either free of prohibited contexts or to include one or more prohibited contexts and/or meanings. In particular embodiments, the server may include one or more, such as a plurality, of processing engines, configured for performing one or more steps in an evaluation processing pipeline whereby one or more words in a message to be transmitted are evaluated in relation to one another in a manner to not only determine their meaning, individually, but also collectively, in context.

For instance, a first content moderation and evaluation server may be provided for receiving a communication, such as from a first user, e.g., an inmate, using the first client computing device to draft and send the communication, and for reviewing and evaluating the communication. As indicated, the server may include a number of processing engines that are configured for performing the evaluation processes. Accordingly, a first processing engine may be provided, such as where the first processing engine is configured for implementing instructions for receiving the raw communication, e.g., such as from an application running on a first client computing device, and for subjecting the communication to one or more filters, such as a set of pre-filters. For example, one or more prefilters may be provided such as where the prefilters are configured for identifying one or more words or images within the communication, or the communication as a whole, which might be associated with one or more potential concerns to the moderating authority, so as to produce identified words or images of potential concern.

A second processing engine may also be provided where the second processing engine is configured for implementing instructions for retrieving from the database, e.g., structured database, the data pertaining to one or more keywords or images of actual concern. Such data may further detail both the type of concern to the moderating authority and the level of concern, so as to produce retrieved data of words and images of actual concern. In certain instances, the data pertaining to one or more keywords or images of actual concern may be embodied by one or more models that have been generated by being presented a number of instances of communications containing known prohibited content and/or communications known to not contain prohibited content, from which instances the model has been trained to recognize content that is or is not prohibited within appropriate contexts.

A third processing engine may further be provided, where the third processing engine may be configured for implementing instructions for comparing one or more of the identified words or images of potential concern, identified in the communication to be reviewed and assessed, to the data of words and images of actual concern retrieved by the second processing engine, and determining a level of correspondence between the identified words or images of potential concern to the retrieved data of words and images of actual concern. In this regard, content contained within one or more messages of a communication can be compared against, or otherwise be evaluated by, a model trained to recognize prohibited content within its relevant contexts. In this manner, the presence or absence of prohibited content within a communication can be potentially, e.g., provisionally, be identified.

A fourth processing engine may also be provided, where the fourth processing engine may be configured for implementing instructions for performing a first likelihood determination so as to determine a first likelihood that the identified words or images of potential concern are proportionally equivalent to the retrieved words and images of actual concern, e.g., the model. Along these lines, with respect to the words or images that have been identified as being of potential concern, the processing engine may further be configured to produce or otherwise identify a type of concern and a level of concern for each of the identified words or images of potential concern. In such instances, each of the type of concern and level of concern that have been identified for each of the words or images of potential concern may then be given a second relative weighting.

A fifth processing engine may additionally be provided, such as where the fifth processing engine may be configured for implementing instructions for performing a second likelihood determination for determining a second likelihood that the raw communication can be transmitted to a recipient without harm. In such an instance, the second likelihood determination may be based at least partially on a comparison of the first relative weighting to the second relative weighting. In various instances, a sixth processing engine may be configured for implementing instructions for either passing the communication on for transmission to the recipient, or flagging and/or sequestering the communication and thereby preventing it from being transmitted to the recipient. Particularly, when the second relative weighting is equal to or greater than the first relative weighting, this may be indicative that the communication includes prohibited content, and therefore should be prevented from being sent.

Accordingly, in one aspect, provided herein are systems, apparatuses, and methods for generating, moderating, and/or evaluating a communication to be transmitted from a first party, e.g., an inmate, to a second party, e.g., a non-incarcerated associate of the inmate. In such an instance, the system may include a plurality of client computing devices, such as a first client computing device, running a client application of the system, whereby the first party may use the first client computing device to draft and transmit a communication to the second party. A second client computing device, therefore, may also be provided, such as where the second party uses the second client computing device, running the client application of the system, to receive, read, and/or respond to the received message.

In various embodiments, the first and/or second client computing devices may each include a display coupled therewith. The display is configured for displaying a graphical user interface, such as to the first individual using the first client computing device to compose a communication, and to the second individual using the second client computing device to read the composed communication. In particular embodiments, the graphical user interface is configured for generating an interactive dashboard for presentation via the display, such as where the interactive dashboard is configured for presenting a dialog box to the first individual and for receiving content therein, from the first individual, for generating the communication to be composed. Likewise, an interactive dashboard may be generated and presented to the second client computing device for allowing the second user to be able to receive and read and/or reply to the received communication. In particular embodiments, a third client computing device may be provided, whereby a further interactive dashboard interface may be generated and configured for allowing a third-party monitor, such as a correctional facility officer, to review and approve or disapprove the communication for transmission. Accordingly, the first, second, third, and any other client computing device of the system may include a communications module for transmitting one or more communication via an associated network connection, such as a wired, wireless, WIFI, API, SDK, or other such network connection.

The communication and moderation system may include a database, which in some instances, may be a structured database. The database may be coupled to any of the first, second, or third client computing devices via the network connection, and may be configured to contain a plurality of libraries. For instance, a first library may be included, where the first library may store data pertaining to one or more keywords, such as where the keywords represent those word that have been determined to be of concern to a moderating authority, e.g., defined prohibited content. In various embodiments, the data pertaining to one or more keywords may be represented by a model that has been generated and trained to recognize prohibited content within a determined context. In various embodiments, a second library may be included whereby the second library stores one or more rules for applying the one or more keywords of concern, e.g., a model, to the identified words or word fragments that are contained in the communication to be transmitted.

The communication system may further include a server system that may be coupled to the structured database and one or more of the client computing devices via the network connection. The server system may be configured for generating a project builder, whereby the project builder may be configured for generating a graphical user interface at a display of the client computing device via the network connection for local display thereby. The server system may include one or more CPUs or GPUs that may further be configured for implementing instructions for performing one or more of the following operations.

Particularly, a server of the system, e.g., may be configured for generating a dialog box for display at the graphical user interface of the first client computing device via the interactive dashboard. The dialog box is configured for receiving inputs, e.g., content, from the first individual, such as via a keyboard being presented at, or being otherwise associated with, the dialog box so as to generate a completed communication. In a manner such as this, the first individual, e.g., the inmate, may draft a communication that can be transmitted within the system to a selected recipient. Consequently, the server may be configured for receiving the completed communication from the interactive dashboard, via the network connection, and for determining the contextual meaning of the individual words and/or word fragments within the communication.

For instance, in determining the contextual meaning of the individual words and/or word fragments within the communication, the server may compare the individual words and/or word fragments of the communication to the data pertaining to the one or more keywords, e.g., a model generated by the system. In such an instance, the comparing may include applying at least one of the one or more rules to both the individual words and/or word fragments to the data pertaining to the one or more keywords, e.g., the generated model, so as to determine if a level of correspondence between them is above a determined set point. Accordingly, when the level of correspondence between the individual words and/or word fragments to the data pertaining to the one or more keywords is above the determined set point, then the server may sequester the completed communication for storage within a library of the structured database.

In various embodiments, the performance of the comparison may further include determining a first likelihood that the individual words and/or word fragments are proportionally equivalent to the one or more keywords, e.g., the generated model, and determining a second likelihood that the communication can be transmitted to a recipient without harm. In such an instance, the determining of the first likelihood may include mapping each individual word and/or word fragment to the one or more keywords, e.g., of one or more models, whereby each keyword may be associated with a type and a level of concern so as to determine the type of concern and level of concern for each individual word and/or word fragment. In various embodiments, the determining of the second likelihood may include applying a first relative weight to each word and/or word fragment, whereby the first relative weight may be based on both the type of concern and the level of concern and a degree of correspondence between each individual word and/or word fragment and the one or more keywords, or models.

More particularly, in various embodiments, the server system may further include an inference engine. For instance, the inference engine may be configured for accessing one or more libraries of the structured database and determining a number of known instances between one or more of an instance of a relationship between each individual word and/or word fragment and the one or more keywords, e.g., models. Such an instance may be used as a weighting that can represent the degree to which the word or word fragments used in the communication compares to one or more of the models used in the comparison. Likewise, the inference engine may be configured for determining an instance of a relationship between the word or word fragments used in the communication and the type and the level of concern, whereby for each known instance, a weighting for the respective relationship is increased, where the greater the weighting the greater the likelihood of a violation is determined to be.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

The summary of the disclosure described above is non-limiting and other features and advantages of the disclosed apparatus and methods will be apparent from the following detailed description of the disclosure, and from the claims.

### BRIEF DESCRIPTION OF THE DRAWINGS

FIG. 1 illustrates a schematic diagram of an exemplary embodiment of a system for substantial real-time communication and moderation.

FIG. 2A illustrates an exemplary embodiment of dashboard interface showing a plurality of sentiment indicators detailing a predicted sentiment of a population.

FIG. 2B illustrates another exemplary embodiment of dashboard interface showing a plurality of sentiment indicators detailing a predicted sentiment of a population over time.

FIG. 3 illustrates an embodiment of exemplary results obtained from the performance of a text moderation evaluation, in accordance with the teachings of the disclosure.

FIG. 4 illustrates a schematic diagram of another exemplary embodiment of a system for substantial real-time communication and moderation.

FIG. 5A illustrates an exemplary process diagram for moderating a communication to be sent via the system of FIG. 1 or 4, in accordance with the teachings of the disclosure.

FIG. 5B present a process diagram that further illustrates the exemplary process of FIG. 4 for moderating a communication to be sent in accordance with the teachings of the disclosure.

FIG. 6 illustrates an exemplary process diagram for transmitting and moderating a communication in accordance with the teachings of the disclosure.

FIG. 7 illustrates a process diagram exemplifying a process by which a computing device of the system may be registered and configured.

FIG. 8 illustrates a process diagram exemplifying a process by which a system user may be registered so as to be authorized to engage the system for substantial real-time communication.

FIG. 9 illustrates a process diagram exemplifying a process by which a system user may be issued a password by which to access the system.

FIG. 10 illustrates a process diagram exemplifying a process by which a system user may register to receive a client computing device of the system.

FIG. 11 illustrates a process diagram exemplifying a process by which a system user may select a subscription by which to access the substantial real-time communication platform.

FIG. 12 illustrates a process diagram exemplifying a process by which a system user may seek a replacement client computing device.

The details of one or more embodiments are set forth in the accompanying drawings and the description below. Other features and advantages will be apparent from the description and drawings, and from the claims.

### DETAILED DESCRIPTION OF THE DISCLOSURE

The present disclosure is directed to devices, systems, and methods for generating, moderating, and/or evaluating communications, such as in a manner that overcomes the issues present in the archaic messaging systems currently in use today. For instance, as indicated above, there are several problems with the legacy, kiosk-based e-mail systems currently being employed in correctional facilities. Specifically, it is recognized that in order for rehabilitation to be effective, inmates need to be able to perceive themselves not as secluded, isolated rejects of society, but as vital members of a community within which they have a unique and necessary voice. This is not possible if they have no ability to connect with anyone outside of the jails and prisons within which they are incarcerated. Lack of connection to broader communities, embodying aspirational community values, is a prominent cause leading to recidivism. So being, what is needed for creating connection and building community for those who are currently incarcerated, but are seeking rehabilitation, is a mechanism by which to create community connection and a manner by which bridges may be built with broader communities.

The archaic e-mail systems, requiring manual review, while at the same time generating a large number of false positives, leads to substantial delays in the communications process, and, consequently, the breakdown in feelings of connection and community. No person is an island, but without the ability to feel connection, and without being able to build bridges of community, anyone will begin to feel alone and isolated, and this is what tends to occur during the delays caused by the necessity of the manual review process required by the archaic communications systems currently being practiced. These delays in the communication process lead to breakdowns in communications, broken connections, increased frustration, feelings of isolation, and loneliness. As these feelings build up, the overall sentiment of the prison community begins to degrade, and the possibility of a more threatening environment increases. What is needed, therefore, is a reliable, fast, and easily accessible platform by which communications can be sent and received, substantially, real time. Specifically, what is needed is a substantially real-time, instant messaging system, whereby a platform is provided within which one or more of: messages can be drafted, reviewed, monitored, evaluated, sent, and/or sequestered, such as autonomously and substantially at real-time.

Consequently, what is provided herein, is a chat-based application for use in autonomous monitored communication monitoring, review, and/or sequestration or transmission, such as in contexts where it is useful to monitor the content of messaging being sent from a first party to a second party, for instance, for use in the correctional industry. Particularly, presented herein is a communication, e.g., an instant messaging, platform that may be employed in the government enforcement, counter surveillance, correctional industries, and the like, so as to provide the ability for those under surveillance and/or correctional remediation, e.g., inmates, to opportunistically communicate with others, such as loved ones, friends, and family outside of the system, while at the same time as preventing deleterious or abhorrent content from being sent back and forth, which can otherwise have damaging results for the population on the whole.

The heart of the substantially instant messaging system, herein provided, is a communications platform that can be employed in a correctional facility environment but in a manner that allows inmates to communicate with others, such as loved ones outside of the correctional system, so that they can easily stay connected with those whom they are attached, while at the same time as allowing those responsible for maintaining public safety to ensure that the communications being transmitted do not contain content that could lead to further infringement of the law and/or public harm, such as within the prison community. For example, to facilitate the smooth, easy, and rapid exchange of communications, the present system may automate the monitoring of communications, e.g., messaging, content so as to identify, tag, and/or isolate communications, or specific content therein, which may be associated in some manner or form with harm to the communicators, other third parties, a local population, or to society at large. Such communications can include text, audio, video, and the like, including attachments, automations, links, etc.

Specifically, a substantially instant messaging platform for significantly real-time messaging back and forth between two parties, is provided, wherein the messaging platform includes an analytics system that has been extensively trained, formulated, and structured to both recognize prohibited words, phrases, catch-phrases, and the like, commonly (or uncommonly) used in messaging, not only through the words used, but also by the contexts within which those words are used. In these regards, the analytics platform is configured for identifying prohibited content, such as by determining the context of one or more messages within a communication, or portions thereof, such as by determining the meaning of words within context of sentence fragments, sentences, paragraphs, stories, and the like. In this manner, a third party, e.g., correctional officer, or the system itself, e.g., autonomously, may monitor, categorize, excise, and/or modify communications content in a manner so as to expedite the monitoring and exchange of safe, confidential, and mass transmission of communications.

Accordingly, the presented analytics system is constructed to recognize problematic content and contexts, in a manner such that messages to be transmitted can be immediately and autonomously reviewed, both while being written and/or being sent. More specifically, based on the focused and extensive training of the various modules of the analytics system, the context of various messages within a communication can be determined, and a threat level provoked thereby may be assessed. Further, centered on the assessments of the analytics platform, a threat level may be determined, and a remedial action can be determined and taken, which provides for substantially real-time, e.g., instant, messaging moderation and/or transmission.

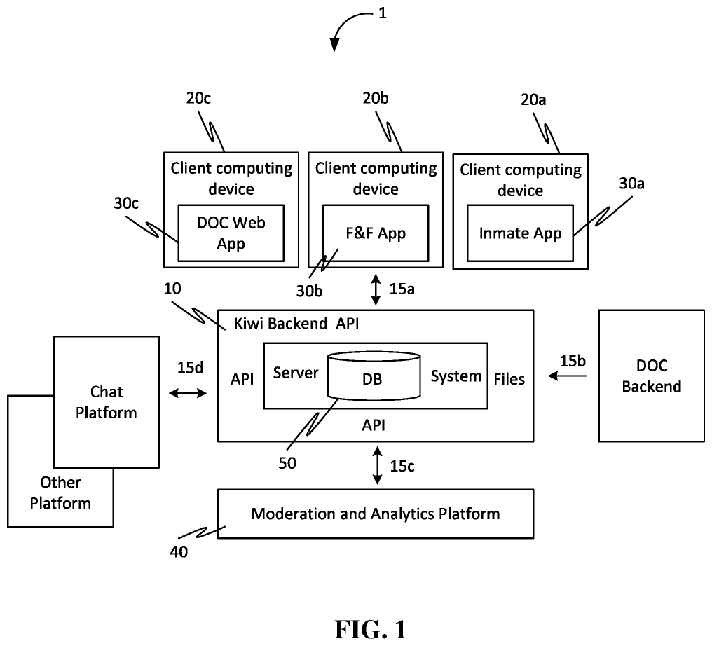

Particularly, as can be seen with respect to FIG. 1, in one aspect, a substantially real-time communications platform 1 is provided. More particularly, the present real-time messaging platform solves the problems with archaic communication regimes, such as by allowing substantially real-time content moderation, review, and assessment. A unique feature of the real-time review performed by the present analytics system is that the analytics system recognizes and/or derives the meaning of words, word parts, such as phonemes, sentences and sentence fragments, so as to generate a contextual understanding of the content of both sentences and paragraphs used in a communication. This contextual meaning can be derived both for written messages and attachments, such as including images and video files, and it may be performed substantially contemporaneously with the drafting and/or transmitting of the communication.

Provided herein, therefore, is a communication platform 1, e.g., a chat-based platform, for securely transmitting communications to and from a plurality of correspondents. In various instances, the system is configured for not only transmitting messages, but also for evaluating the messages mid-transmission, such as where it is important that certain content or content elements not be transmitted. More particularly, the substantially real-time messaging platform may include one or more servers 10 that may be coupled, such as via a wireless internet connection, to one or more client computing devices 20a, 20b, and 20c, together which from the backbone of the communications platform 1. For instance, as illustrated in FIG. 1, the chat based, e.g., instant messaging, system 1 provided herein, may include one or more servers 10 that are configured for monitoring, reviewing, evaluating, sequestering, remediating, and/or transmitting communications, which may be in an instant messaging format. In various embodiments, the one or more servers 10 may be communicably coupled, such as via a network 15a, 15b, 15c, 15d, e.g., wired, wireless, API or SDK connection, to one or more client computing devices 20.

Specifically, in various embodiments, a server 10 of the system may be configured for communicating with one or more client computing devices 20, such as via a downloadable application 30a, 30b, 30c, or other executable instructions, running on each client computing device 20, whereby through the client application 30, delivery of communications may be effectuated from one client computing device 20a, such as from an inmate composing a communication, to another client computing device 20b, such as another inmate receiving and reviewing the communication from the first inmate, such as via the client application 30. In particular embodiments, the drafting, receiving, monitoring, reviewing, and/or sequestering or approving of communications may be performed through interaction of the server 10 with the client computing device 20, such as via the client application 30, e.g., in some instances, a mobile application, running on the client computing device. In such regards, one or more of the server 10 and the client computing device 20 may be configured for implementing instructions for one or more of generating, monitoring, reviewing, sequestering, approving, transmitting, and/or receiving a communication. Consequently, the system 1 may include, one or more, e.g., a plurality of first, second, third, etc., client computing devices 20, such as where each client computing device includes a display, such as an interactive touchscreen display having a graphical user interface (GUI) through which one or more inputs may be made.

In such instances, the substantially real-time messaging platform 1 may include one or more servers 10 that may be coupled to one or more first and second client computing devices 20a and 20b, such as where the first client computing device(s) 20a is configured for generating a graphical user interface through which a user, such as an inmate, may access the system and/or draft or deliver, e.g., a previously drafted, communication, such as via the graphical user interface, to a second client computing device 20b, such as of a communication recipient, who desires to read the received communication. The second client computing device 20a, therefore, may also include a display screen, such as a capacitive sensitive touch-screen display through which a graphic user interface (GUI) may be generated and displayed. More specifically, as indicated, the first client computing device 20a may include a downloadable application 30a, such as an inmate-based application (e.g., a first client application 30a running on a first client computing device 20a). Likewise, the second client computing device 20b may include a downloadable application 30b, such as a Friends and Family-based application (e.g., a second client application 30b running on a second client computing device 20b). A third downloadable application 30c running on a third client computing device 20c may also be provided, such as where the third downloadable application 30c allows for review of the communication attempting to be sent from the first client computing device 20a to the second client computing device 20b prior to its transmission.

In various embodiments, the downloadable application 30, or other executable instructions, may be configured to run on the client computing device 20. In certain instances, a client computing device 20 of the disclosure may be coupled to the system server 10, as described herein, such as via a network connection and/or via a suitably configured wireless, wired, or even through an API or SDK connection. In particular instances, the downloadable application 20 may form the backbone of the instant message transmission system. For instance, the client application may adapted for generating a graphical user interface, or other input interface, at the display of the client computing device 20. However, in other instances, the server system 20 may include a project builder that is configured for generating the graphical user interface at the client computing device 20. In particular embodiments, the graphical user interface (or the project builder), in turn, may be configured for generating a desktop interface through which a user of the system may engage in one or more operations of the system, such as for one or more of entering, retrieving, evaluating, and/or generating data, such as for composing, reviewing, and evaluating communication content. Hence, the first 20a and/or second 20b client computing devices may be configured for generating and receiving communications, one from the other, and the server 10 may be configured for receiving the communications. A moderation and/or analytics module 40 of the system 1 may be configured for analyzing and evaluating the communications upon receipt from one client computing device 20a but prior to transmission to the second client computing device 20b.

As indicated, in various instances, one or more servers 20 of the system may further be coupled to one or more third client computing devices 20c, such as a third client computing device configured for receiving, monitoring, reviewing, assessing, approving, and/or sequestering, the generated and/or transmitted communication. Alternatively, the moderation and/or analytics module 40 of the system 1 may be configured for autonomously receiving, monitoring, reviewing, assessing, approving, and/or sequestering, the generated and/or transmitted communication In such an instance, the system 1 may be configured for automatically monitoring, flagging, reviewing, classifying, categorizing, sequestering, and/or transmitting the communication autonomously, or the system may present a moderation desktop at the client computing device 20c through which a human in real life can review, approve, or disapprove communications potentially to be transmitted. In this regard, the system may pre-view the messages to be sent, can flag and highlight the potentially prohibited content, and can classify the same with regard to the harm potentially associated with the flagged content. Flagged material, therefore, can be presented to the human reviewer, who can then review the content, and decide if the system generated flags were correct, and if so, approve the message for being sequestered, and if not, can over-ride the system and approve the communication for transmission.

In any of these instances, the client computing device 20 may include a graphical user interface, such as for generating and/or displaying a dashboard interface, e.g., at the GUI, which can be employed for transcribing, transmitting, reviewing, and/or receiving a drafted communication, such as for review and/or response thereto, dependent on the configuration of the client application 30 running on the client computing device 20. The server 10, therefore, may be configured for receiving the communications and evaluating them, such as by applying one or more comparisons and/or rules to the communication and determining whether or not the message includes prohibited, e.g., threatening, content, and the system itself can flag and/or sequester the content, or the system can present the flagged content to a human reviewer who can then decide whether to sequester the content. In various instances, as described in greater detail herein, the system may be coupled to a model or rules-based analytics platform, such as through a network or API connection, whereby the one or more models or rules may be applied to a communication received by the server.

Particularly, the server 10 may be configured for receiving the communications and evaluating them, such as by applying one or more models or rules to the communication, and determining whether or not the message includes prohibited, e.g., threatening, content. In various instances, as described in greater detail herein, the system may be coupled to both an analytics platform 40, such as a rules- and/or model-based analytics platform, which analytics platform is coupled to a database 50, which stores one or more generated models and/or rules, through a network 15, API, SDK, or other connection, whereby the analytics module 40 may access the database 50 so as to apply the one or more models and/or rules to the communications received by the server 10. The system 1, therefore, includes one or more servers 10 that may be coupled to one or more databases 50 storing the one or more models, rules, and/or other data pertaining thereto. In such instances, the one or more models and rules may be configured for determining whether a communication to be evaluated includes prohibited content, such as words, phrases, meanings, and the like, which evaluation is not merely word based, but rather, may be context based. In particular instances, images, videos, and other attachments can also be evaluated.

Hence, in various instances, one or more servers 10 of the system may include a set of prohibition analysis processing engines, one or more of which is configured for reviewing, identifying, comparing, assessing, classifying, categorizing, and/or flagging each instance where a prohibited word, phrase, image, or stream of images, is used. In such instances, for each prohibited instance a flag may be generated, e.g., indicating the flagged word or words or sentences or sentence fragments should be evaluated, and a comparison may be made between the flagged content and one or more models or rules, such as stored within a database 50 of the system 1, for instance, to determine the meaning of each of the words within the sentences and/or paragraphs of the communication, and to then determine the context of the words, sentences, and paragraphs of the communication, and in so doing determining if the communication includes prohibited content.

In particular instances, in relating the models and/or rules to the communication, the server 10, or the analytics platform 40 thereof, may apply one or more weights to one or more evaluative factors by which the communication content can be determined, defined, and in some instances, scored. Accordingly, the analytics system 40 of the communications platform 1 may have a series of prohibition analysis processing engines, whereby the series of processing engines may include one or more processing engines configured for receiving, e.g., from the first client computing device 20a, the communication, evaluating the communication, which may include comparing the communication, or a fragment thereof, to one or more models or rules, weighting and scoring various features of the communication or its contents, so at to provide weighted and/or scored content, and based on the weighting and scoring determining whether the communication can be transmitted or should be prevented from being further transmitted, such as to a recipient user of the second client computing device 20b. Consequently, the system server 10 may be a contextual analysis server that includes one or more analytic processing engines for sequestering a communication, or a portion thereof, and one or more processing engines for transmitting the communication, or a portion thereof, such as for display at the graphical user interface of the second computing device 20b.

Accordingly, in particular instances, the contextual analysis server may be configured for determining one or more context for the content of the communication. In such instances, contextual analysis server may have a plurality of processing engines for evaluating a communication so as to determine the context of its content, and based on that context, defining each contextual element of the communication. Further, based on the determined contextual elements of the communication, the context analysis server may then further determine if the communication includes prohibited content. In such instances, in performing the contextual analyses, the context analysis server may include one or more prohibition analysis processing engines configured for retrieving, e.g., from the database 50, one or more models or rules, such as where the one or more models or rules have been identified as being applicable to the communication and its content, applying those models and/or rules to the communication, and weighting and scoring all or a portion of its content.

In such instances, the system 1 may track the instruments and methods by which the models and/or rules are applied to the content, how they are weighted, and how they scored, and ultimately, how the decision to sequester or transmit the communication or parts was made so as to determine analytic data pertinent thereto. These analytics may be categorized, stored, and retrieved for review by a system user, or the system itself. In such an instance, the system and/or a user thereof may review how the models and/or rules were developed and applied. The system itself, or a user thereof, can decide whether to transmit the communication anyway, e.g., over-ride the system's original prohibition, or to accept the prohibition. Hence, in these regards, once received the communication can be embedded with metadata so as to track its generation, receipt, and user throughout the system.

In certain embodiments, the one or more sets of prohibition analysis processing engines of the analytics system may include one or more processing engines that have been precisely configured, such as through the running of hundreds to thousands, to hundreds of thousands, to millions of models so as to be able to more efficiently recognize both words, sentences, paragraphs and stories, as well as their contexts. of communications seeking to be transmitted. The accurately recognizing of contextual elements from which actual context can be determined is a useful tool for determining the overall context of a statement, sentence, paragraph, or story, from which the meaning of individual words used in the communication can be defined, thereby allowing for a more accurate determination of whether the communication contains threatening and/or prohibited content. Such threatening and/or prohibited content may be prohibited based on its content, regardless of content, or based on its context, whereby, once identified, the material that is threatening and/or prohibited may be defined, e.g., contextually, may be assessed and flagged, and appropriate actions can be taken by the system in response thereto.

In these regards, the analytics system may include one or more content filters, such as word, word-fragment, and/or phoneme filters, as well as one or more context filters, which may be tuned to one or more word groups, sentence fragments, sentences, and the like. For instance, one or more content filters, e.g., pre-filters, may include a flag dictionary, which is used to identify words and word fragments, which on their face are intrinsically threatening and/or prohibited, such as being directed to threats, violence, weapons, drugs, paraphernalia, and the like. In other instances, one or more context filters, e.g., pre-filters, may be included so as to understand if a communication contains prohibited content based on the structure, content, and context of words in combination, sentence fragments, sentences, and sentence groupings. Such context filters may include one or more classification and/or category filters.

Specifically, with respect to classifying and/or categorizing received messaging and its content, the system can employ a variety of further filters by which to evaluate the messaging so as to classify and categorize the content thereof, such as with respect the intrinsic context of the communication itself. For instance, the messaging within a communication, and its content elements, can be parsed and its words and/or phrases can be analyzed and classified, such as based on one or more of the characteristics of the content elements. These content elements can then be used to determine the context of the message, which can then be used to categorize the content elements contextually, such as based on content type, violation type, and/or level of threat that could occur to an individual and/or a population of people if the communication is allowed to be transmitted to the recipient.

For example, in various embodiments, a pre-drafting filter may be applied, e.g., during the drafting of the messaging content but prior to its transmission. Likewise, a post-drafting but pre-transmission filter may be applied, e.g., after the drafting of the messaging but prior to its transmission to the recipient. Additionally, a reply filter may be applied, such as in response to a received message that is to be replied to. Any or a multiplicity of these filters may be applied to the communication, the communication messaging, and the communication content, such as during the composing and/or transmission processes, and the communication and its content can be classified and/or categorized with respect to the type and level of threat the communication poses, whereby when communication messaging and content includes prohibited material that arises to a predicted threat level, e.g., arises above a determined set point, a message being composed or transmitted can be flagged and/or sequestered.

Where a filter is applied during the composition process, a warning can be given for words and/or content that are likely to be prohibited and/or cause sequestration. In such an instance, the composer can be notified of the abridgement, why, and can be told what the consequences will be if the message is sent. Such filtering can be based on a weighting and scoring regime, as described herein, where based on a weighted and scored probability, content predicted to be threatening may be flagged and/or banned, such as where the prediction corresponds to the likelihood of adverse consequences occurring if the communication is transmitted. The described filtering may be based on words or word parts, phrases or phrase parts, meanings, contexts, images, sentiments, and/or the conveyance of detected emotions. For instance, the messaging and its content can be broken down, classified based on the meaning of its content, which can be determined and categorized by type, such as with regard to whether the content pertains to violence, nudity, graphic content, controlled substances, substance abuse, alcohol, money laundering, and the like.

Further, the content can be classified based on a level of concern the messaging is predicted to provoke within a population or community. In such an instance, based on the level of concern, a variety of reactions can occur. For instance, where the content is provocative but not salacious or graphic, a lower level of concern can be provoked, and in such an instance, the message may be transmitted, but a simple reminder may be presented to one or more of the sender and the recipient, reminding them that such content is verging on being unacceptable. However, where the content is salacious, such as deemed to be pornographic or violent to the extent of being graphic, the message may be sequestered and a more forceful warning may be presented to the sender and/or recipient. But, where the content actually describes violent or other threatening acts that are to occur, then the message may be sequestered, and the sender and/or the receiver may be put on a time-out, during which period they may be blocked from sending and/or receiving messages.

For these purposes, the system administrator can engage with the system so as to determine the rules that determine the various classifications that will be employed and what types of categories the messages are to be evaluated with respect to, and the rules that define the various degrees of threat that will be acceptable and what will not be acceptable, as well as determining the resultant consequences if the defined rules are broken. For example, a scale may be defined and employed such that for non-invasive, first infringements, minimal reminders or warnings may be given, with limited to no time-outs being given, but for frequent and blatant abridgements of the rules, much longer timeouts, including blocking altogether, and/or other chastisements may be administered.

Accordingly, in one exemplary embodiment, provided herein is a system for evaluating content on behalf of a first party, e.g., a correctional facility officer, in charge of maintaining the safety and security of a plurality of secondary (inmates) and/or third parties (friends and family of the inmate). For instance, the first party may include a number of individuals, such as healthcare workers, guardians, clinicians, or the like, working at a facility that is in charge of ensuring the well-being of a group of patients, inmates, subjects, and the like. Particularly, a population of members of the first party, e.g., healthcare workers or guardians, may be represented by the place where they work, such as a hospital, facility, institution, or other establishment, where that establishment is charged with the securing of and caring for others, e.g., a retained population of second parties, e.g., patients or inmates.

More particularly, in such an instance, the health professional or guardian population may be tasked with ensuring the safety of the retained patient or inmate population that is housed within the establishment. In certain instances, the health professionals or guardians may further be charged with protecting a number of third parties, e.g., a free population, from a risk that the retained population may pose to the free population. In a particular embodiment, the establishment is a correctional facility and the first party is a collection of guardians or guards who are tasked with securing a second party of inmates in a manner so as to ensure the protection of a general population of people who are not incarcerated.

However, simply because the second population is comprised of a number of retained individuals that for safety purposes needs be physically separated from a general population, it does not mean they must be prohibited from communicating with those in the retained and/or general population. In fact, in many instances, it is desirable that the members of the retained population have communicative access to those in the free population. But, this communicative access is not without restraints, such as where the communication may pose a threat to another member of the retained population or any members of the general population. Hence, it is useful to monitor the communications between members of the retained population and others.

A problem with such monitoring, however, is that it is invasive, doesn't allow for the free flow of information, and connectivity and/or intimacy may be compromised between individuals when they know their communications are being monitored. This is undesirable where communications between two parties helps maintain a healthy emotional connection and bond between them in a manner that is not in any way threatening to anyone else. What is needed, therefore and provided herein is a system where two parties can communicate, e.g., by sending communications back and forth to one another, whereby the messages they send are free from human observation, and yet, the content of those messages are nevertheless evaluated so as to ensure that deleterious content is not conveyed.

As described in greater detail herein, the system includes a plurality of computing devices, by which the two communicants can send messages back and forth, such as via an application running on each respective computing device, and a server exchange for receiving, evaluating, and in some cases transmitting the messages between correspondents. For instance, the system may include a client computing device having a display coupled therewith. The display may be configured for presenting a graphical user interface, e.g., to the first individual using the client computing device, such as where the server via the graphical user interface is adapted for generating an interactive dashboard for presentation at the display.

The generated interactive dashboard is configured for presenting an input screen for allowing the first individual to input, e.g., by engaging with an associated input device, a message into the client computing device, which message may then be transferred to the system server over a network connection, such as by a suitably configured communications module of the computing device. In various instances, the application running on the client computing device may be configured for helping the first communicator to draft the message, such as by suggesting wording and phrases to be included in the message. In particular instances, the system may be configured for presenting an interactive interview to the first user so as to determine subject matter to be proposed to the user for inclusion in the messaging, whereby answers to previously presented questions are used by the system to determine subsequent questions to be presented to the composition composer.

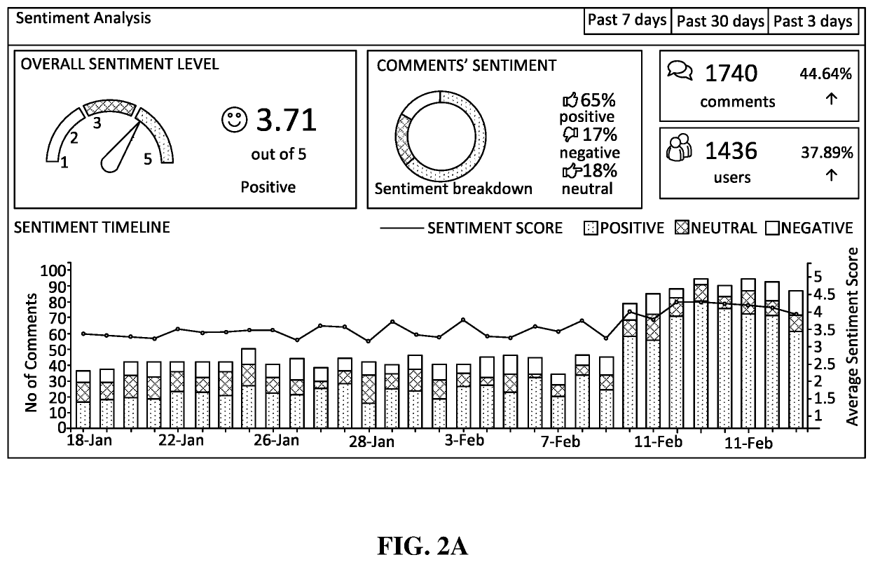

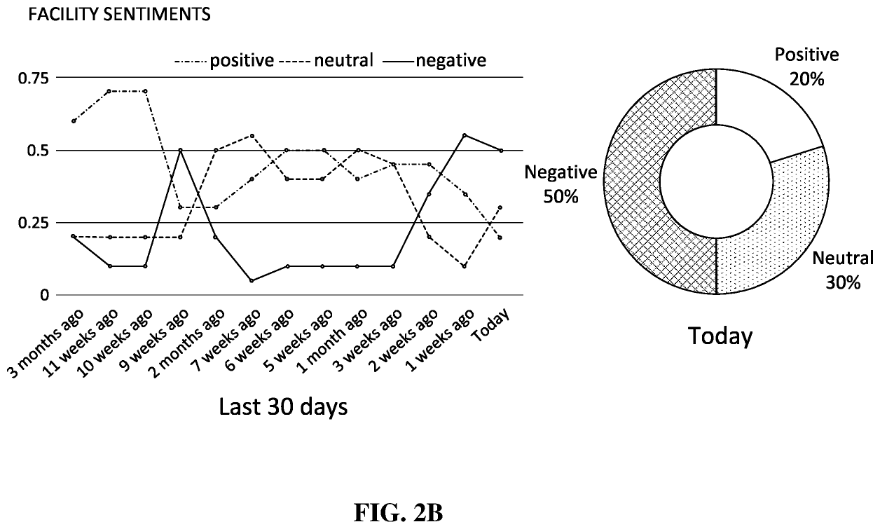

Additionally, in various embodiments, as can be seen with respect to FIGS. 2A and 2B, the analytics system may include one or more sentiment analysis engines for determining one or more sentiments being conveyed within a message being drafted and/or transmitted. For instance, the analytics system may include, or otherwise be associated with, an AI moderation module, which AI module may be configured for reviewing messaging content, and based on its contexts, determining a sentiment of the message, the sentiment of the overall communication, and/or the overall sentiment of a population of a community, such as by examining a plurality of communications with respect to a certain sentimental elements, such as via batch processing. For instance, sentiment can be determined, scored, and presented on a scale, such as from 1 to 5 or 1 to 10, etc., and can be used to characterize content within a message, the message or communication itself, or a batch of communications, such as where an overall sentiment for one or more populations within a facility may be determined and presented.

As can be seen in FIG. 2A, the analytics system may be configured for analyzing the content of a collection of comments, and can determine if the content is positive, neutral, or negative with respect to one or more characteristics of a defined sentiment, and each message can be flagged and tracked accordingly. This can be presented at a dashboard interface of a display of a computing device of the system. The analytics system can further perform both a qualitative and quantitative measurement of the sentiment, which can further be presented at the dashboard interface. For instance, sentiments can be measured and scored, such as between 0-5 (0 being negative, 3 being neutral and 5 being positive), or they may be labelled accordingly, such as neutral, positive, or negative.

Particularly, the system can identify, tag, and label messages, the messages can be aggregated per label, and analytics can be run on the flagged messages. In this instance, the sentiment of the messages reviewed indicate 65% of the messaging related to a given topic is positive, 17% are negative, and 18% are neutral. This data may be presented in one or more charts, such as in a sentiment thermometer chart showing sentiment from 1 to 5, in this instance, 3.71, which is largely positive, or it may be presented in a ring chart that shows the percentage breakdown of the sentiment. The number of comments fitting into each category, as well as the number of users making those comments can also be presented. A bar graph showing the evolution of sentiment over time, such as hourly, daily, weekly, monthly, and yearly may be presented.

Likewise, as shown in FIG. 2B, the sentiment can be broken down by sentiment, by topic, by sentiment over time, and the like. This sentiment analysis can be determined for a given time period, for a given sub-population, or over a number of different facilities. For instance, a line graph showing the evolution of sentiment, e.g., on a weekly basis, over one or more months may be presented, such as where positive, neutral, and negative sentiment each being tracked and presented in the line graph. Likewise, the daily (or weekly, monthly, etc.) sentiment can be summarized and presented in a ring chart showing the current degree of positive, neutral, and negative sentiment for the facility, or a population thereof.

As indicated, in particular embodiments, the system analytics may be run in conjunction with a suitably configured artificial intelligence module of the system. Particularly, the analytics system of the communications monitoring platform may include one or more, e.g., a plurality, of AI modules. For instance, in one embodiment, the analytics system may include three, four, or more artificial intelligence (AI) modules, where each AI module has been trained in a different manner, by different data, so as to be tuned to determine and process different information in a different manner than the other various AI modules of the system. For example, in one embodiment, the analytics system may include a first AI module, such as an AI Moderator, for performing communications moderation, and may further include a second AI module, such as an Investigator AI, such as for performing investigations. Additionally, a third AI module may also be included, such for performing special operations pursuant to moderating the substantially instant messaging platform during the transmission of communications.

More particularly, the AI moderator may be configured for scanning across all media, substantially real-time, collecting, reviewing, assessing, evaluating, and monitoring communications for prohibited content, such as content containing materials that violate one or more defined criteria. For instance, the moderation AI module is configured for monitoring all communications being transmitted across the platform, such as to identify any potential communication violations, to characterize the communication participants as well as their communication elements, and to determine one or more trends in communication and/or, as indicated, overall sentiment.

Specifically, there are basically four different types of communication media that the system is finely tuned to moderate: text based messages, image and video content, along with audio content. Each different media content type can be moderated by the same AI moderating module, or each communication type can be moderated by its own individually-trained and content specific moderating AI sub-module. In such an instance, the system can deploy at least four different AI moderating sub-modules, such as an AI module for moderating text content, an AI module for moderating image content, an AI module for monitoring video content, and an AI module for moderating audio content. In such an instance, each module may be trained with content specific for the type of content that AI module is configured to monitor and/or moderate. Hence, where there are four moderating sub-modules, being individually trained so as to be content type specific, than each AI module will employ its own individual models by which to perform its analysis.

A unique feature, however, of all of the AI modules, in these regards, is that they are able to identify and define words and images, not just based on their dictionary meaning, but, rather, also based on their meaning within the context they are used. In essence, the AI modules of the system are configured for determining and recognizing the context of a message or image, and from that context deriving meaning for the message and the content thereof, and in view of that derived meaning determining if the messages or images include prohibited content and/or what the overall sentiment of the message is individually, or as a collection of messages. More particularly, the AI modules of the system may be trained so as to be able to recognize contextual elements of words and images as they are deployed as part of a bigger, overall communication or as a collection, e.g., a batch, of communications.

Accordingly, with respect to training the AI modules of the platform, generally, first, a model is generated for solving a problem, and in this instance, the problem is whether the groups of words or images within a message within a communication contain prohibited content? In order to answer this question definitively, the system should be able to understand the context of the content it is evaluating. In order to recognize and understand the context of a communication, therefore, the AI module generates a model, and then trains the model to recognize content elements that individually or together provide a context for any given message. When the model is applied by the module correctly it is rewarded, and when the model is applied incorrectly, it is punished.

For instance, in training the model, an AI module of the platform is provided content that on its face is prohibited and content on its face that is not prohibited. The module then must decide for each instance, into which category the presented content fits, prohibited or non-prohibited. This forms a basic model for making an evaluation. In this regard, the model begins as a mathematical equation that is implemented in software that is configured to mimic a neural network. The AI module then learns to recognize this prohibited content and non-prohibited content, much like a brain learns to give meaning to words and images. Hence, when a prohibited word is recognized, it is flagged when it is next experienced. Whereas when non prohibited content is recognized, it is not flagged. In this regard, the prohibited content is provided within a prohibited context, and likewise for the non-prohibited content. The basic rules that the AI module starts with is that when prohibited words/images are present they are prohibited on their face.

Then the AI module is provided content that may or may not be prohibited, based on its context, and when the system makes a call that is correct, the system is rewarded, and a weighting of the system configuration for the evaluation process is increased. When the call is incorrect, the system is punished, and a weighting of the system configuration for that evaluation process is decreased. This training is continued again and again with ever increasing difficulty in the contextual indicators of violation or no violation. In this manner, the model develops more complicated rules and learns to assess for prohibited content not just on the presence of prohibited words or images, based on their context.

Accordingly, the basic model is fed training data, where the answer is known, e.g., examples of correct and incorrect calls are provided, and when the model makes a correct call it is rewarded, when it makes an incorrect call it is punished. Thus, the model learns from the copious amounts of training data and intelligence it is provided. As more and more complex data sets are fed into the system, the model develops more and more complex rules, the intelligence of the neural network increases, and the module adapts the ability to self-learn, from the increased complexity of the example sets fed into the AI module.

In essence, the training begins with prohibited and/or non-prohibited words being fed into the system, then words that are prohibited but in non-prohibited contexts, as well as prohibited words that are in prohibited contexts, are fed into the system. Then non-prohibited words but in prohibited contexts are provided, so on and so forth. The AI module is then fed one sentence, multiple sentences, paragraphs, and the like. This process is repeated for each prohibited content type, texts, images, audio, video, etc. in a multiplicity of different contextual situations. Specifically, examples of all types of violations and non-violations, for all types of prohibited content, are fed into the system, such as on the order of tens of thousands to hundreds of thousands to millions. The model then self learns to understand the context and what the meaning of the words, sentences, paragraphs of a communication are, and then generates scores based on each of the different violations.

The model goes over the training data again and again, multiple times, and with each pass it keeps self-correcting and self-learning, becoming more and more intelligent, and more capable of identifying true-positive hits, with each pass. Accordingly, the more training the model is subjected to, the more unique it becomes, the more diverse the training material is, the more diverse the model becomes, all of which makes the various AI modules disclosed herein unique from general purpose computing architectures. In a manner such as this, each AI module learns to become an expert at recognizing prohibited content of its trained type, regardless of the context, and/or recognizing prohibited context, regardless of whether the words employed are prohibitory or not.

In various embodiments, various data of the correspondents may also be collected, such as with regard to one or more characteristics of the message sender or recipient, such as their age, gender, race, ethnicity, socio-economic background, demographics, groups they belong to, and other such characteristic data and the like. This data can be useful when certain groups use words collectively to mean something different from the way those words are used by other different groups, such as in code. In this manner, the model may be trained not just to recognize words, within the context, but may also recognize the character and nature of the persons participating in the communication. This gives better accuracy to the evaluations being made, so as to better avoid making false positives, or missing true hits.

Because of the unique and extensive training of the models, the AI modules of the system are completely different from any general analytics system, which have not gone through the extensive trainings as have the present AI modules. Thus, the results of the analyses derived from a general analytics processing functionality will in no way be as accurate or capable of performing the tasks herein disclosed, within appropriate contexts, and with as great as accuracy, and as rapidly. So being, the models of the present AI modules are adapted to continuously improve over time, and thus, the training is continuous, and in real time. Particularly, on a constant basis, a subset of the thousands to hundreds of thousands to millions of communications being sent through the system can be retrieved, such as where, the subset of these communications can be flagged for both system as well as human review. The differences between the automated versus the human review may be noted and fed back into the system, and where the system made a wrong call, e.g., called something prohibited that was not or let prohibited content be transmitted, the model may be retrained, based on the human feedback, again and again, until the right call is made. In various instances, this training may be conducted on a regular and continuous basis, such that there is no downtime in the system. Analytics may be run on the system so as to determine where any given evaluation went wrong, and the system configurations can be changed to correct any issues.

Likewise, along with training the AI module with respect to the type of content it will moderate, each module can also be trained specifically, and/or differently, with respect to the types of violations each module (or sub-module) monitors. For example, there may be moderation AI sub-modules that are configured for monitoring for different types of violations and/or with respect to different types of categories of violation within each type of violation, such as with regard to violation types, such as content referring to drugs, contraband, gang activities, threats, violence, escape activities, and the like. Any number of violation types and categories may be defined by each individual facility deploying the communication monitoring platform, but in such instances, each module may be specifically trained to precisely model the types of content violations for which it is dedicated to monitor.

As indicated, each content media type, e.g., text, images, audio, etc. may have different types of violations and categories associated therewith, as each module may be trained differently, with different types of data. For instance, salacious and nude content types as well as depictions of graphic violence are more likely to be embodied in images and video, rather than in text or audio media. Similarly, there can be different categories for audio and video as well. Accordingly, there may be a separate training process for each different type of media, e.g., text versus images and audio, and with regard to each different type of AI module, such as moderation versus investigation versus operational, and thus, each different AI architecture may employ a different analytics model by which to assess the data. Consequently, there may be separate AI models for assessing text and/or audio content from assessing image or video content, and there may be separate AI models for assessing each of text, image, audio, and video media types.

In various embodiments, however, with respect to monitoring image and/or video content, in certain instances, there may be two aspects of moderation, whereby the various AI modules act synergistically together. First, the image itself may contain a violation, such as depicting violence, weapons, drugs, etc. Then, secondly, there may be texts embedded in the image. In many instances, this may be recognized and picked up by the image moderation module directly. However, in certain instances, the text-based elements may be isolated and then passed through the text-based moderation module. Hence, in particular instances, in evaluating images, in a first pass, the image itself may be evaluated, e.g., by the image processing module, and then in a second pass, the individual content items containing texts embedded within the image may be evaluated, e.g., by the text-based module.

Likewise, with respect to audio moderation, the audio files may be analyzed directly, or there may also be two parts of the evaluation. For instance, first the audio may be converted into text, and then the text may be passed through the text-based analysis module. The same is true for video moderation, which may be analyzed directly by the video moderation module of the system, but the content may also be broken down into its component parts: images, audio, and texts, and thus, may be analyzed by both the image moderating module and the audio/text-based moderation module(s), such as when the audio is isolated, turned into texts, and then evaluated. Thus, the system can divide content streams into their component parts, and then analyze them in accordance with their respective channels. Accordingly, each AI module may be set up based on how it is configured, and based on the system parameters that affect its usage, and can be configured to function independently, or in combination with, the other AI modules.

Specifically, in particular embodiments, the system can analyze system parameters as well as the various communications being transmitted through the system, and can determine which form of processing is to be performed, on what material, by what processing facility, e.g., such as by a moderation, investigation, and/or an operationally configured AI module and when, such as in response to one or more triggering events. For instance, with respect to performing moderation, the system may be set up such that a user of the system, e.g., a communication moderator, engaging with a moderation portion of the analytics system, via a dashboard interface presented at a display of their client computing device, can access the system, and review a selection of communications that are of questionable nature, have been flagged by the system for review, and which communications are presentable at the graphic user interface at the display of the client computing device for review. Likewise, a user of the system, engaging with an investigative portion of the analytics system, via their client computing device, can initiate one or more queries. In response thereto, the on-demand, investigative portion of the analytics system, may then reconfigure itself so as to perform an analysis so as to determine and generate an answer in response to the query. The operational portion of the AI module can be engaged with in like manner.

In such an instance, the moderation portion of the AI may scan and capture communications being transmitted throughout the population, and thus, may generate the raw data that may then be passed on to the investigative portion of the AI for analysis thereby, such as for determining one or more trends in the conversations taking place and captured by the moderation portion of the AI. Hence, in this instance, the moderation tool may actively be monitoring communications so as to determine potential violations in communications, but when acted upon by the investigative portion of the AI, may further be employed to identify and collect content as required by the investigation AI module. For example, a correctional facility officer, e.g., a guard, can query the system regarding all inmates that have used a particular term of interest “X,” and in response thereto, the system can then analyze all correspondences, identify the inmates that have used the term “X,” such as by flagging all inmates with hits, and can then return all flagged inmates to the correctional facility officer, e.g., guard, such as via the dashboard interface, e.g., running on the guard's client computing device.

Once the results have been returned, the query can be narrowed, or expanded, such as where the guard can ask the system to return all associates of the flagged inmates. In response thereto, the system can then generate a cluster, such as a cluster graph, or generate a table, showing all system identified associates of the flagged inmates, thereby producing more flagged hits. Further, once clustered or tabled, some or all of the flagged hits, and the correspondences they have sent and received, can then be analyzed by the system so as to identify one or more trends, such as a trend that somehow connects all of the identified hits. For instance, one male inmate may be known to have committed a given crime, such as a financial crime. His correspondences may then be analyzed by the system to determine the type and form of the language he uses. This language can then be used to generate a model that can be used to analyze the communication patterns of others.

Hence, the analytics modules of the system can determine various language patterns being used by one or more users. The system can then analyze all correspondences from others to determine if the same language patterns are being used by others, and if so, those users can be flagged for further examination to determine if they are engaging, or have engaged, in the same or similar financial crimes. Consequently, the correspondents using the system can be identified and clustered, such as by an investigative configuration of the analytics system, based on the language and structures used in generating their correspondences. Other data can be used to cluster the users of the system as well. Specifically, a variety of different analytics may be performed on the various users of the system, in this case inmates, so as to characterize each of the individual users, such as with respect to one or more defined classifications and/or in accordance with one or more categories.

In a manner such as this, inmates can be both classified and categorized, such as with respect to their activities, and a level of threat those activities represent to a larger community. One or more predictions may also be made by the system, such as in regard to a likelihood of the inmate to pose a threat, or to engage in prohibited activity, both inside or outside of the correctional facility. Accordingly, based on the training of the various different AI modules, each individual AI module may be configured to perform a series of unique tasks, and thus, each specific AI module may be case specific based on how it is to be used, such as including a moderation, investigation, and/or an operational function. Any number of AI modules can be trained, configured, and deployed in the performance of the objectives of the system, whereby the various different AI modules may be daisy chained together such that results of one set of analyses from a first AI module generates the data to be employed by a second AI module performing a second set of analyses. In such instances, each unique AI module may be trained differently on different types of data, so as to generate different models. Consequently, these models can be changed and customized for any specific correctional facility, based on their specific needs, and as trained on their specific data.

Hence, even though each facility may employ the same system fundamentals, e.g., each facility will employ an AI module for monitoring communications, the way each moderating module functions will inevitably diverge over time, from modules employed in different facilities, so as to become more and more catered for the requirements of each independent facility's system. Particularly, each facility can have their own classifications, their own categories of analyses, and their own types of violations they want to detect based on their own individual policies. So being, different AI modules having different areas of focus and/or operation can be customized to the needs of each particular facility that deploys the communications moderation platform.

In operation, the backbone of the substantially instant messaging platform 1 is a client application 30. Particularly, in crafting a communication to be transmitted, a user of a client computing device 20 may access the communications platform 1, via a client application 30 running on their client computing device 20. Specifically, the client application 30 is configured for generating a dashboard interface, at a display of the client computing device, at which dashboard interface a communication to be generated and/or transmitted may be input. More particularly, the communication may be drafted and entered into the dashboard interface by engaging an input device, e.g., a keyboard, of the client computing device 20, by which keyboard the communication can be typed out. Alternatively, the communication may be entered into the client application 30 by engaging directly with a graphical user interface generated at the display of the client computing device 20. However, in other instances, the client application 30 may be configured such that the data to be input, e.g., a communication to be generated, may be entered such as through a voice command. In such an instance, the client application 30 may be configured such that a user may engage an activation switch or button, either physically or via voice command, and once activated may speak into a microphone of the device, so as to verbally enter data, e.g., a communication, into the system.

Accordingly, the dashboard interface may include a screen or viewer upon which one or more operations that may be performed may viewed, and/or a user dashboard may be presented, which dashboard, as disclosed herein, may display information about the various rules governing the communication platform, may display a list of those to whom a communication may be sent, an inbox and sent box including previously sent communications can be viewed, a communication builder configured for helping a user to draft a communication may be presented, a language translator may be included, and a message drafting interface, whereby a communication can be drafted. Additionally, as indicated, in various embodiments, the dashboard, displayable on a display screen of the client apparatus, tablet, phone or watch, may include a user engagement interface that allows the user to activate the microphone of the device, such as through tapping or otherwise activating the system, so as to receive a voice command from the user.

The voice command may be in natural language, and may be with reference to describing a communication proposed to be drafted. Upon receiving a voice command, such as an order, the system, via the mobile computing device, may then transmit the voice command to a central server, such as to the AI module of the system. The AI module may be configured to include a voice recognition and/or modulation module that is capable of receiving and determining the meaning behind a user's voice commands, and may then initiate one or more routines within the system to effectuate the users command, such as with respect to effectuating and order and/or delivery thereof. The voice data may be received and/or entered into the system via a suitably configured application programming interface, API, or SDK. Once received by the system, the communication may be interpreted by the system, e.g., a speech recognition application, whereby the language will be parsed, and relevant data, e.g., communication content, may be entered into the system. The system may then forward a confirmatory message back to the device of the user so as to allow the user to confirm that the system has correctly interpreted the voice command.

Once the communication has been entered, via the client application 30 running on the client computing device 20, it may then be transmitted, via the client application 30, to a system server 10, e.g., a central or remote server, whereby the communication and its content can be reviewed and evaluated, such as by a suitably configured analytics platform 40 of the system 1. Particularly, the communication can be assessed by one or more of the aforementioned, trained AI modules of the analytics platform 40. In these regards, in various embodiments, one or more, e.g., all, of the AI modules 40 may be implemented within the same server system 10, which may be a centralized or remote server.

However, in other embodiments, one or more of the AI modules may be implemented by different server systems, such as where one AI module may be implemented locally, such as on a client computing device 20 itself, or a server 10 to which the client computing device 20 is coupled, e.g., via a network connection, and one or more other AI modules may be implemented remotely, such as by being embodied in a cloud infrastructure. In those instances where the server is a remote server, the remote server may be made accessible via a suitably configured application programming interface (API), such as via a proprietary API, or via suitably configured software developers kit (SDK). As described above, each AI module may differ from the others by the manner by which it is trained, or more specifically, by the data employed in training each different AI module, and further, by what kind of data in considers and the calculations it performs. Hence, the various different AI modules of the system, such as moderation, investigations, and operations, or other AI modules, may be trained in-house, and deployed remotely, or they may be trained and deployed remotely or locally.

Regardless of where the AI modules are deployed, as soon as a communication is drafted and sent, the various pre-filters, AI modules, filters, and post filters may be activated, as necessary, to review, moderate, investigate, assess, and perform operations with respect to the communication to be transmitted. Particularly, upon initial transmission, the communication can be subjected to one or more prefilters or quick-pass AI modules, whereby an initial determination can be made as to whether the communication contains any content of questionable nature, and if the communication does not include any questionable material, it may be passed straight through to the recipient. In this manner, the communications process may near real-time messaging. However, based on the number and type of violations a communication potentially contains, may determine the number of filters and/or AI modules a communication may have to pass through, which in turn may determine the number and length of latencies that occur. Nevertheless, because of the use of specialized filters as well as because of the extensive training of the AI modules, the analytics system of the communications moderating platform is specifically designed to allow for moderation and assessment, but also very low latency.

In various embodiments, such as where latency is not an issue, e.g., where the results of processing are not needed immediately, batch processing of communications, may be performed. For instance, in certain instances, a number of communications can be batched and analyzed so as to determine one or more trends in the communications on the whole. For example, various communications, or copies thereof, can be sequestered, batched, and then be subjected to a specialized review, such as so as to determine an overall sentiment of one or more segments of a populations the communications of which are being monitored. Specifically, batch processing of communications allows for certain queries to be made so as to determine one or more trends, which in this instance, may be a trend in sentiment, such as with regard to whether the overall sentiment is positive or negative.

As described above, in particular embodiments, the reviewing, assessing, and evaluating of content may include comparing one or more messages within a communication in questions against one or more previously generated and tested models, whereby the contextual significance of any given message within a communication can be determined based on its correspondence to one or more stored or newly generated models. Accordingly, with regard to monitoring and/or moderation, such as of text or image-based massaging, etc., texts or images can be monitored for inclusion of prohibited content, e.g., violations, and for those communications that include such content, the communication, as a whole, or the content itself, can be flagged, evaluated, weighed and scored, such as to the characterization and the extent of the infringement. Specifically, each violation can be identified, e.g., contextually, classified, characterized, such as with regard to the category of infringement, and it can be scored with respect to one or more characteristics, such as threat level.

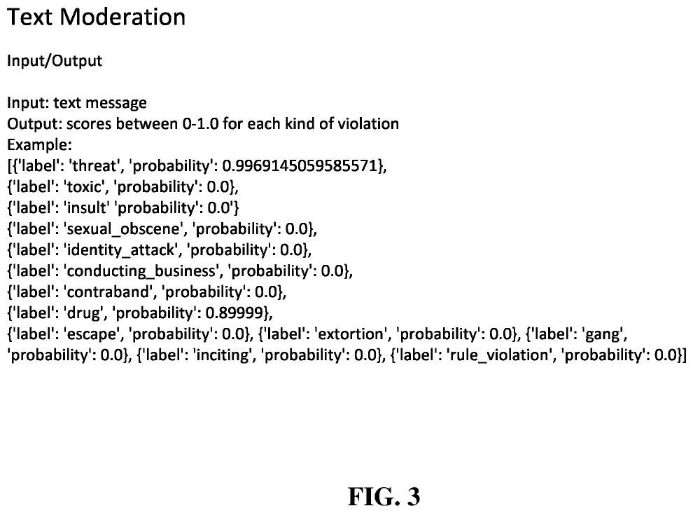

In particular embodiments, a prediction may be made by the system as regarding the potentiality that the subject matter of a communication is likely to contain prohibited content or not. See, for example, FIG. 3. Accordingly, any message within the system can be evaluated with regard to whether it includes prohibited content, and each suspected instance of potential violation can be assessed with regard to the likelihood an actual violation is present and/or the likelihood that threatened action may actually be performed, e.g., perpetrated. Once classified, characterized, categorized, scored, a confidence given, one or more remedial actions can be assessed and suggested for implementation, and upon approval, can be automatically and autonomously implemented by the system. In assessing a remedial action to be taken, the system may collect other data, so as to determine the overall mood of the population, and may use population sentiment data so as to determine a type and a level of remedial action to be taken.

In this regard, as described herein with respect to FIGS. 2A and 2B, one or more AI modules may be trained to recognize and evaluate positive and negative emotional content, and thus, may be configured to determine an overall sentiment of the population, as well as to quantify that sentiment. In a manner such as this, a demand may be made for the system to analyze all correspondence, such as within a given time frame, with respect to a given sub-population of the overall environment, to determine the topics being discussed, and whether they are being talked about in a positive or negative manner. This sentiment analysis may be performed so as to determine an overall sentiment of the environment, or a sentiment associated with one or more identified topics, such as politics, girls, sports, and the like. Batch processing is useful in these types of analyses. This kind of information is not time sensitive, and thus, is ideal for batch processing, which can be scheduled to be performed at a regular time, such as between the hours of midnight and 3 or 4 A.M. On demand processing can also be performed. On demand processing need not be performed regularly, or on a scheduled basis, but can be performed as and when demanded.

As can be seen with respect to FIG. 3, all of this information can be summarized and reported to system users with the right authorizations, such as a correctional facility officer. Such a summary may include the various violations that may be assessed, and the probability, e.g., confidence, that the violation may also be determined and presented. For instance, for text message moderation, violations can be defined as: sex, drugs, threats, gangs (related talk), contraband, escape, conducting business, and the like. Likewise, for images, the violations can be: explicit nudity, suggestive nudity, physical or graphic violence, weapons, contraband, self-injury, visually disturbing (corpses, dead bodies, etc.), drugs, hate symbols, and the like. Hence, each module may be attuned to a different media type, and may be tuned to recognize different violations, or the same violations, but with different definitions for what constitutes a violation based on that particular media type, and based on each particular facility deploying the platform. Further, each AI module may be tuned with a different sensitivity, e.g., weighting, for what rises to the level of a violation.

In these regards, each AI module for each different media type may be trained based on its specialized use cases and the type of violations on which it focuses. Each potential violation, e.g., designated by its label, may be presented, and the probability that such violation is present in the message can also be presented, such as where the likelihood runs from 0.0 (100% confidence that the violating content is not present) to 1.0 (100% confidence that the violating content is present). Accordingly, the moderation AI module can evaluate communications and the messages therein for potential violations, the violations can be identified, and a probability score that such violative content is present can also be determined, scored, and presented for each potential violation.

As shown in FIG. 3, all of this information, in this regard, a text moderation analysis result, along with the score, can be summarized and put into a report to be presented to a system user, such as a corrections officer. Specifically, the text moderation module can define any term as a prohibited term, and can score the probability that the prohibited term is contained within a message, so the text moderation tool can attribute a score, e.g., probability, for each defined violation. So, FIG. 3 is an example of what an output from a text moderation model looks like. It includes a label, which designates the kind of violation, and then there is a score assigned to that label, representing the confidence that the content in question is present. In this regard, the moderation AI module implements a model that takes in one or more text messages, and scores the content of the message across one or more, e.g., all, of the different violations that have been defined. In this instance, the message being evaluated is likely to include a “threat,” which has a probability of 0.9969. So, that means that the model is very confident that this is a threatening message. However, the system has also indicated that the message is also likely to contain “drug” content, which has a probability of 0.8999. Thus, the message includes two potential violations, and thus, falls within two separate categories: Threat and Drug related.

Further, once a violation has been determined, the system can determine one or more actions to be taken in response to the presence of the determined violation. For example, the system can be configured so that anything that the models gives a score greater than 0.85-0.9 should be blocked. This scale can be determined as per choice, such as anything above 50%, or 60%, of 70%, or 80%, etc. can be a demarcation as to when a communication is more likely than not to contain prohibited content, and should, therefore, be sequestered. In this instance, when the moderation AI module returns a score above 0.85 or 0.9 or 0.95 or 0.98 or above, the communication can be flagged, and sequestered.

Furthermore, with respect to the investigative side of the AI system, the investigations AI module is configured for reviewing and assessing a number of the overall communications being run through the platform, and may compare content elements of the communications currently being transmitted throughout the system to one or more content-based models so as to determine one or more trends in communication currently occurring in the correctional facility. In this manner, the investigative AI may be configured to determine changes in word usage, anomalies in word usage, variances, and the like, and from these data can determine if various words are being used to represent other words, e.g., coding, such as by determining the context within which the word in question is used, and from that context defining the word, not based on its dictionary definition, but rather based on how it is being used within its context.

Likewise, different communications and/or association patterns of communicators can be determined, such as where one inmate begins communicating with another they have not previously communicated with, or are now communicating with at a higher or lower frequency. In these regards, the investigative AI module can analyze patterns and trends within the communications system, and based on the determined patterns or trends, can make one or more predictions as to sentiments or actions that may take place based on the predictive analysis. One or more remedial actions can be analyzed and suggested to the correctional officers to perform so as to prevent or promote the predicted outcome. Consequently, prohibitive, e.g., threatening, sentiments or behavior, e.g., threatening gang behavior, can be predicted, use of slang words to represent prohibited words can be identified, and corrective measures can be planned and suggested, all autonomously and automatically by the investigative AI module.

For example, if a sub-population starts referring to a certain type of drug as “Slack,” the investigative AI module can recognize the inconsistency between the word “slack's” definition and typical usage, and the way it is currently being used, and based on this new usage, a new “contextual” definition can be developed, and the system can highlight that a given word has taken on a new meaning, and in this instance, has taken on the meaning of a drug. Accordingly, the investigative AI can develop several models, and based on the models, almost immediately determine the words in communications that are not being used in their typical manner and can derive their new meanings within their current contexts.

Once a new contextual meaning is giving to a word, then the system can track the use of that new word across communications being transmitted through the platform. In this regard, and form of search term can be queried, analyzed, and the results thereof can be returned along with one or more predictive analysis being made with respect thereto. Thus, all words being used that have a same contextual meaning, even if the words are different, can be identified, and the messages using them can be sequestered and presented for review, such as at a desktop display of a client computing device being deployed by a monitoring authority.

Additionally, with regard to the operations side of the AI system, the operations AI module is configured for monitoring the overall communications platform, which may include the comparing of communications currently being transmitted throughout the system to one or more sentiment-based models so as to determine a sentiment type and a sentiment level of a defined population, such as within the correctional facility. In a manner such as this, a correctional facility Officer can log onto the system, via the desktop application running on the client computing device, can access the operational AI module, and get a feel for what the general, or specific, mood of the prison community. In certain instances, the sentiment, such as with regard to any defined characteristic can be scaled and ranked, such as from 1 to a 5 or 10, where 1 is non problematic and the sentiment becomes worse with increasing numbers, from good to neutral to bad to worst, which can be dependent upon the types and content of the communications being transmitted. The topics of various communications, or batches of communications, can also be monitored and compared against one or more models to determine what topics are trending and whether they are trending in a negative or positive manner. This analysis can be performed on various real-time or batched communications.

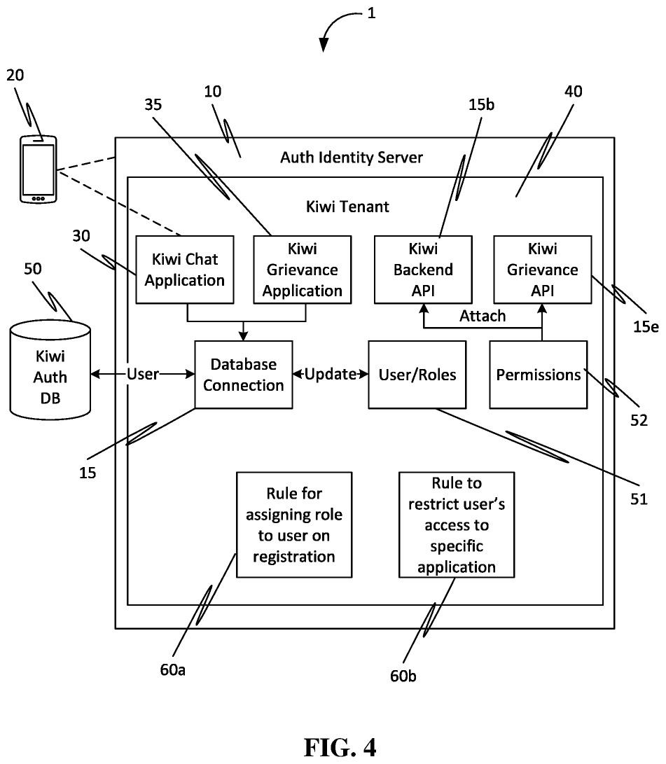

As can be seen with respect to FIG. 4, the substantially instant messaging and monitoring system may be configured for monitoring conversations, monitoring sentiments of one or more populations within an environment in which those conversations are happening, and allowing members of the population to communicate with one another, such as inmates to inmates, guards to guards, inmates to guards, and/or inmates to those outside of the facility in which they are incarcerated. As indicated above, the substantially instant messaging and monitoring platform may include a plurality of servers 10, through which communications can be drafted, sent, reviewed, transmitted, or be flagged and/or sequestered. In these regards, the server system 10 may be in communication with one or more client computing devices 20, whereby each client computing device 20 runs a substantially instant messaging client application 30, through which a user of the client computing device may access the communication platform and draft, send, and monitor communications, dependent on the user roles 51 and permissions 52 of each user. For instance, a user who performs the role of 51 of a guard, will have different accesses and permission 52, than a user who is an inmate.

Accordingly, as shown in FIG. 4, in one configuration, the system 1 may include a local or remote server 10 that is configured for authenticating the roles 51 and permissions 52 of platform users, thereby allowing them to access the system so as to communicate with other system users and/or to monitor such communications. As indicated, regardless of the user role 51 and permissions 52, each user may access the communications platform through a client messaging application 30 running on a client computing device 20 of the system, such as a mobile phone, tablet computing device, or laptop computer, and the like. In various embodiments, the server 10 may be remote from the client-computing device 20, such as where the server may be a cloud-based server. In such instances, the cloud-based server 10 may be connectable via a network to one or more of the client apparatuses 20, e.g., client computers, e.g., desktop or laptop computer, and/or client computing devices, such as mobile smart telephones, tablets, or smart watches, and the like, running the client application 30. In various instances, the cloud-based server 10a of the communications system 1 may be in communication with a plurality of local servers 10b and/or client computing devices 20 that are located throughout one or more facilities in one or more geographical regions being serviced by the communication infrastructure.

Therefore, as explained above, the communication system 1 may be configured for wired or wireless network connection and communication, whereby communication generation and/or communication transmission may be performed via one or more computing devices located remotely from one another. In particular instances, wired or wireless communication may take place, such as via network interface, e.g., API, SDK, or the like, or wireless communication may be conducted via a cellular, WIFI, Bluetooth, or other wireless interface. In either instance, the network connection is configured for effectuating the transfer of data from a transmitter of the computing device 20a to a receiver of the server 10. As described in greater detail herein, in various instances, the system 1 may include a data analytics and processing module 40, for processing data, e.g., communication data, prior to, during, or after transmission.

Accordingly, communication throughout the system may be conducted via one or more communications modules employing one or more communications protocols over one or more networks. For instance, the various apparatuses of the system may be configured for wired or wireless communication, and thus, may include a wireless transmitter, a typical transmitter may be a radio frequency (RF) transmitter, a cellular transmitter, WIFI, and/or a Bluetooth®, such as a low energy Bluetooth® transmitter unit. In some instances, a typical receiver may include a satellite based geolocation system or other mechanism for determining the position of an object in three-dimensional space. For example, the geolocation system may include one or more technologies such as a Global Navigation Satellite System (GNSS). Exemplary GNSS systems that enable accurate geolocation can include GPS in the United States, Globalnaya navigatsionnaya sputnikovaya sistema (GLONASS) in Russia, Galileo in the European Union, and/or BeiDou System (BDS) in China.

Hence, the substantially instant messaging system 1 may include a mobile communications device, e.g., a tablet computer 20 having a wireless communications module that is in communication with one or more servers 10 and/or other client computing devices 20, such as via a wireless internet or cellular connection. Consequently, in certain instances, the components of the system can be interconnected by any form or medium of digital data communication, e.g., a communication network. Examples of communication networks include a local area network (“LAN”) and a wide area network (“WAN”), e.g., the Internet. Particularly, the relationship of server and client arises by virtue of computer programs or firmware, e.g., software programs and applications, or hardware configurations, running on the respective computing devices and having a client-server relationship to each other. In this instance, the client application 30 may be an application program including machine instructions that, when executed by a processor of the client computing device 20 cause the processor to perform certain programed functions, as herein described.

In various instances, where a communicator or monitor of the system is using a client computing device 20 to draft, send, read, and/or monitor communications, the system may automatically determine the location of the user so as to best determine where in a given environment the accessing and/or use of the system is occurring. For instance, as disclosed herein below, an aspect of the disclosure is a mobile application or “APP” 30, which app may be built in or downloadable onto a mobile or wireless computing device 20, such as a mobile telephone or tablet or portable computing device, which computing device is configured to allow a user to rapidly connect to the communications server 10, and pull up a communication dashboard at a graphical user interface (GUI) of the client computing device 30, whereby through the GUI the user can generate and/or read and/or review a communication. In such an instance, the system may be configured for automatically determining the user's location, such as via location data entered into the app, or by a unique RFID of the client computing device 30 they are using in conjunction with the application, and the like.

Particularly, in certain instances, the interactive user interface presented at the display of the client computing device 20 may present one or more interactive screens, where each screen is directed to a different aspect of the communications system 1. For instance, the client user interface may be a graphical display for presenting a real-time list of system users, inmates or guards, friends and family, and the like, who can be communicated with, such as by clicking on the name of the person to whom the communication is desired to be sent. Once an addressee is selected, another screen can be generated into which a communication can be composed, read, evaluated, and/or reviewed. Each user of the system 1, therefore, may engage with a server 10 through the client computing device 20, e.g., desktop or tablet computing device, and the like, for the purpose of drafting and sending communications, tracking the flow of communications, and reviewing communications, via the user interacting with the graphic user interface of the client computing device 20. This configuration, therefore, allows for real-time communicating, monitoring, tracking, and the updating of the communication process flow, all of which may be performed by one or more servers 10 of the system.

Accordingly, a central feature of the substantially real-time communications system 1 is one or more servers 10, such as a remote and/or centralized server, which is capable of being accessed remotely, such as via a cloud-based interface, through a client application 30 running on a client computing device 20. Particularly, as indicated above, in various instances, one or more servers 10 of the system are connectable to one or more of the associated client computing devices 20, e.g., desktop, mobile, devices, via the client application program 30, such as over a communication network. The connection with the one or more servers 10 may be such that each server automatically synchronizes the communications and activities being performed within the system 1, and across all relevant devices, e.g., client computers and mobile device(s), real-time, so as to allow a communication monitor to see the flow of communications throughout the system 1 and to track the sentiment of a population in one or more facilities.

Particularly, in certain instances, the server 10 may be configured for collecting, collating, and/or generating an aggregated state of communications, state of review, and/or delivery of the communications, as well as provide data related to who is doing the communicating, with whom, from where, and at what time, and from which locations, so as to track communications and communication trends across the system 1. This data may be collected and aggregated, compiled, and analyzed, such as by an analytics platform of the system. For instance, during the analysis process, one or more trends or sentiments may be discerned, and predictions pertaining thereto may be made, such as via an artificial intelligence module of the analytics system 40. This trend and/or predictive data may then be prepared for transmission from the server 10 to one or more client application programs 30 of a computing device 20 being operated by a user in the role 51 and with the permissions 52 of a communications monitor. In various instances, the data may be formatted for display in one or more interactive displays being employed within the system, or the data may be transmitted to a third-party device for analysis thereby. Accordingly, an important aspect of the system is the provision of an interactive, real-time monitoring and/or updating, communication platform that allows for substantially real-time messaging, such as via an easy to use client application, such as via a downloadable APP running on a mobile device, table, or client computer.

In one aspect, therefore, a communication server system 10 is provided, wherein the server is communicably connected to one or more associated client devices 30, such as one or more mobile communication devices, such as a cellular phone, tablet computer, laptop computer, smart-watch, and the like, through a client application program 30 running on the client computing device 20, which client application 30 may be a downloadable application, as described herein. In various instances, the client computing device 20 may be communicably coupled to the server system 10, such as over a suitably configured network, such as via a wireless communications protocol, such as via a cellular, RF, Wi-Fi interface, over the cloud. Particularly, each of the client-apparatuses 20 may include at least one processor, a transceiver to communicate with a communications network, and an interactive display.

In various instances, the network connection may be such that it synchronizes the client apparatuses 20 with the server 10 at a time during which one or more activities of drafting sending, monitoring, reviewing, sequestering, or transmitting communications are taking place. In such an instance, the server system 10 may be configured for receiving one or more of the mobile device ID(s), the user ID(s), the user(s) information, and/or the location data for each user of the system 1, such as through the one more client programs 30. Further, the server system 10 may also be configured to authorize one or more users of the system, such as an inmate or guard, so as to allow them to participate in the communication process, such as for drafting, monitoring, and reviewing a monitored communication, as described above. However, in certain instances, one or more of these privileges may be revoked, such as where the rules 60 of the communications system 1 are not being followed, such as in an egregious manner. Accordingly, the server system 10 may be configured for receiving user data, input data or otherwise, and may further be configured for processing that data so as to determine the real-time status of the users of the system and with regard to the communications they are engaging with.

Consequently, in various instances, the server 10 may be configured for receiving and processing communications, communication data, user and/or client apparatus data, and/or communication monitoring, review, and delivery data. As indicated, the system 1 may include a mobile communication device 20 that includes a client application 30 together which may be configured for drafting and directing a communication for transmission, through the endogenous communications module of the client computing device 20, back and forth e.g., between the device 20 and the host server 10, e.g., via the application 30, and/or to one or more recipients. Specifically, in various embodiments, the system 10 may be configured for receiving and transmitting communications and communication data to and from a plurality of client apparatuses 20, such as a multiplicity of communication devices, e.g., desktop computers and/or handheld cellular phones, tablets, and/or smart watches, etc. running the same or similar programming. In such embodiments, one or more, e.g., each, of the software implementations, e.g., client application programs 30 may be configured with a device identifier (ID), for providing a unique device identifier for each device being deployed on the platform, such as for identification, authentication, and/or tracking of the user and the correspondences they draft, send, monitor, and review. Additionally, the client application program 30 of the computing device 30 may further include one or more of a user ID of a user associated with the mobile device, information about the user, and/or location data representing a location of the user and/or mobile device, which may also be communicated to the server system 10, such as for authenticating the user and/or the user's location, with respect to the role 51 they play within the system and their permissions 52. This information may be useful when restricting a user's access to the system.

Accordingly, an aspect of the communications platform is not only to provide access to communications media to authenticated and approved users, but to also restrict access to those whom have not been authorized and/or whose communication privileges have been revoked, such as for failing to abide by the communication rules of the system. As described herein, the system may monitor the communications that flow throughout the platform so as to ensure that the communication rules are being followed so as to ensure that prohibited content is not being transmitted across the communications platform. Where the rules are not being followed by a given user, that user's communications privileges may be revoked. In such an instance, the system 1 may be configured for allowing a communicator to register a grievance against the system, a system administrator, or even another member of the system.

For instance, as can be seen with respect to FIG. 4, along with a system chat and/or messaging platform, a grievance platform 35 may also be provided, whereby grievances can be registered by using the system. In various embodiments, an interface for messaging, e.g., direct messaging, a system administrator may also be provided, such that questions, concerns, and/or general comments can be submitted to a system moderator. In such an embodiment, along with a messaging and chat platform, for messaging other users of the platform, a platform 35 for messaging system administrators, e.g., the healthcare and/or guardians monitoring the system, may also be provided.

In such instances, the system 1 may include a questions or grievance portal 35 which may be configured for being coupled to the system server 10 and/or a database 50 thereof, whereby a user of the system may register their complaints as to how they are treated by other system users, such as those incarcerated, or otherwise housed with them, how they are treated by system administrators, and/or how the various rules 60 of the system, or the establishment generally, are applied to them. In such instances, the grievance portal 35 may be connected to one or more of the system databases or libraries 50, whereby the rules 60 and roles 51 of the pertinent system users may be defined and evaluated, one against the other, such as with respect to a received grievance, and/or one or more restrictions may be reviewed and re-evaluated.

In re-evaluating a restriction or grievance, such as with regard to why a communication was or was not sent, the language and/or other actions that were employed may be reviewed along with the rules that were applied and the various restrictions that resulted. For instance, the communication platform may include a rules and/or model database 60, whereby one or more rules governing the usage of the system may be stored. For instance, one set of rules 60a may define who can use the system and how, which rules essentially define the role of the system user, such as an inmate or a guard, e.g., monitor. Another set of rules may be retained within a penalties or restriction database 60b, whereby the restriction rules are configured to determine whether the rules of the communication system have been followed, or if one or more violations has occurred. In the evaluation process, if there were circumstances that were not accounted for that indicates the rules were not applied properly, the user restrictions may be diminished or removed and any infringement accounted against the suspected violator can be reset. However, if no error was determined, and no relevant mitigating circumstances are found to be present, then the restrictions may be confirmed. This review may be performed autonomously by the system and/or may be performed by a real-life human.

For instance, in one exemplary embodiment, such as in the correctional and/or rehabilitation industry, grievances represent a way for the retained, e.g., inmates, to submit a request, complaint, or the like, to the administrator staff, whereby the administrator may review the reference, follow-up, if necessary, and/or define the next actionable steps to be taken given the circumstances of the grievance. Accordingly, the system may include a grievance portal, extension, or the like, whereby complaints or grievances may be input into and registered by the system. In various embodiments, the grievance portal may be moderated so as to open up a real time chat with a live human or a chat bot configured to intuitively answer the questions, concerns, and/or grievances of a party utilizing the system. In particular instances, as indicated above, each system user may have a designated identification number, which ID may automatically be registered by the system when the user accesses the platform 1, e.g., a grievance portal, thereof. Hence, in certain instances, each system user may have their own default channel, which may be created and available for each registered party.

When accessing the grievance portal, the user may be presented a user screen that details all the past and current active submissions, and they will have the option to create a new complaint. When a new grievance is to be filed, the system may allow a party, such as an inmate, to select 1 out of N pre-designed templates, whereby the aggrieved party may select and fill out a template that best suites the characteristics of their complaint. Once submitted the grievance will be created on the backend, assigned with the ID, and routed to the right administrator group. The administrator assigned to the grievance may be able to reply back with additional messages, and a two-way communications portal may be opened. A message may be sent to the complainant detailing that the grievance was received, the steps that are being taken, as well as the status of the review, e.g., submitted, pending, fulfilled, closed, and the like.

In various instances, the grievance portal may allow a user to access one or more electronic manuals that set forth the rules of the establishment as well as the rules for sending and receiving generated messages, especially with regard to what language that is or is not acceptable. The manuals may be stored within a database within the system. In such an instance, when a system user has a question regarding the administration of the system and/or its components, the questions may be entered into a system interface, an answer may be retrieved by the system, and be presented to the user. The manuals may include rules of the system, regulations, statutes, rights, and/or laws, such as governing system users and/or system usage. A survey may also be presented whereby the user can be queried with regard to whether and to what degree the presented answer satisfies the questions of the user. Likewise, where the answer matches the question, the system analytics may increase one or more weights to the search function, but where the answer does not match the query, various of the parameters of the search function may be re-organized and re-weighted.

In certain instances, where the communications are required to be confidential, a particularized exchange pipeline can be implemented where by the messages can be exchanged in an encrypted platform without monitoring or moderation, otherwise, when the communications are not required to be private or confidential, they may be observed, moderated, and/or recorded. A system chatroom can also be provided for allowing users of the system to interface and communicate together. The chatroom may be configured for allowing system users to communicate amongst themselves, with system administrators or moderators, and/or one or more support facilitators. Such support facilitators may include medical professionals, healthcare workers, psychologist, lawyers, and the like.

However, where the communications are moderated, e.g., electronically by the system or by live moderator, the communications and their content can be adjudicated, e.g., by the system, such as where a given threat level may be flagged and/or indicated on a scale based on the level of threat posed by the communication content, such as a one, meaning there likely is no prohibited content, to two, where the content may be suspect, to three, where the content may be worrisome or bad, to four, where the content is expected to be very bad, to five, where the content is likely to be dangerous, violent, toxic, and/or obscene. Particularly, as explained in greater detail herein, the system 1 may include an analytics module 40 that is configured for monitoring the transmission of communications throughout the system 1, such as from one user to another. During this monitoring process, the content can be subjected to one or more assessments, such to a natural language processing element that is designed to parse the words, combine them into phrases, determine their individual and collective meanings, deduce their context, categorize the words, phrases, and meanings, e.g., within their contexts, and/or then evaluate the content and the messages as a whole. Yet, as described above, in many instances, the system may include an analytics platform whereby the individual and collective meanings of words can be deduced within their context by comparing them to one or more models, having been previously generated and stored within a database of the system. In this manner, the words, phrases, and meanings, e.g., within their contexts, can be defined, categorized, and classified, and/or they may then be evaluated so as to determine the content and meaning of the messages as a whole.

In various instances, the analytics module 40 of the system 1 may further be configured for analyzing and evaluating the content of text communications, but also of figures, videos, and/or other images. In particular instances, it is useful to have the system autonomously and automatically perform this evaluation, such as to ensure a fair, rules-based, unbiased evaluation, rather, than providing circumstances whereby one or more individual's, acting independently, decides what is acceptable and what is not, and from whom. In addition to categorizing the content, the system can classify the meaning of such content, and thereby determine a level of threat to the individual communicants, others, or the community at large.

For instance, in one instance, as described, the words or graphical images in a communication may be run through a dictionary or image repository so as to determine a classical definition and literal meaning of the words. In such an instance, various words, phrases, and/or images known to be incendiary, which can be used in text or voice-based messages, can be rapidly identified and flagged by the system. In various instances, the flagged words or images may then be compared against one or more models, whereby the context of the flagged words or images are determined. In this manner, words or images known to be threatening and/or obscene on their face, such that their use within a communication automatically raises a threat level, can be identified and flagged, such as via a first-pass filter. However, once flagged, the potentially violating words, can be contextually defined, such as by comparison to one or more models, so as to determine if a potential violation by the use of questionable content, is in fact, a violation contextually. Accordingly, a message containing such words can be automatically flagged, sequestered, and the communicant can be identified for further, e.g., second pass, monitoring and evaluation. Such words can include explicatives, superlatives, obscenity, words pertaining to body anatomies, words pertaining to crime, abuse, violence, rape, gangs, gang-violence, gang symbols, self-harm, harm of others, theft, robbery, drug use, weapons, weapon use, gun, handgun, riffle, tobacco, cigarettes, synonyms of the same, and the like.

However, any word, set of words, phrases, meanings, etc., can be entered into or determined by the system for being flagged. For example, a user, such as a system administrator can enter the prohibited communication elements, e.g., words and phrases, such as by entering the prohibited words in a table that can be accessed by a moderator and used to evaluate the words of messages and communications. A set of rules instructing the system as to how to apply the words on the prohibited list and/or models thereof, to the words in the messages, and how to determine the relevant context can also be manually entered into the system, or they may be generated intuitively by the AI of the system learning and applying such words via an intensive training of the system.

Specifically, in particular instances, the system itself may be configured with a set of rules, which rules can further be supplemented by various intuitive learnings of the system. In such an instance, prohibited words can be entered into the system, and from these words various relationships between them and their synonyms, antonyms, and/or other derivations thereof, can be determined by the system, such as by being subjected to one or more training regimes. For instance, one or more modules of the analytics module may be trained by being shown examples of prohibited words being used in prohibited contexts. Once the prohibited words and their prohibited use cases have been modeled, these models may then be used to decide the content of messages and whether they include prohibited words having prohibited meanings. Accordingly, the analytics module of the system can be configured for autonomously identifying prohibited words, or their presence in images or voice messages, sequestering those words, substantially real-time, and thereby facilitating the near free flow of communications.

In particular instances, once sequestered the message can be rehabilitated wherein the offensive language can be excised from the communication, either automatically by the system or by a system moderator, and once cleansed, e.g., redacted, the communication can be transmitted to the directed recipient. For instance, as disclosed herein, the server system may be configured for authorizing the excising and/or prohibition of flagged content deemed to be threatening to one or more individuals, such as where the excision or prohibition may be based on the likelihood that the one or more flagged words or phrases actually contains prohibited content. Likewise, a threat can be characterized, and a threat level may be assessed. The threat level, on a scale of evaluation, can be represented by a number of different indicators, such as numbers from 1 to 5 or 10, colors, flags, and the like. Dependent on the type of threat, threat level, and the number of occurrences, the system may block content from being sent from certain users, or to certain users, or to suspend users, and/or to delete them or their content from the system.

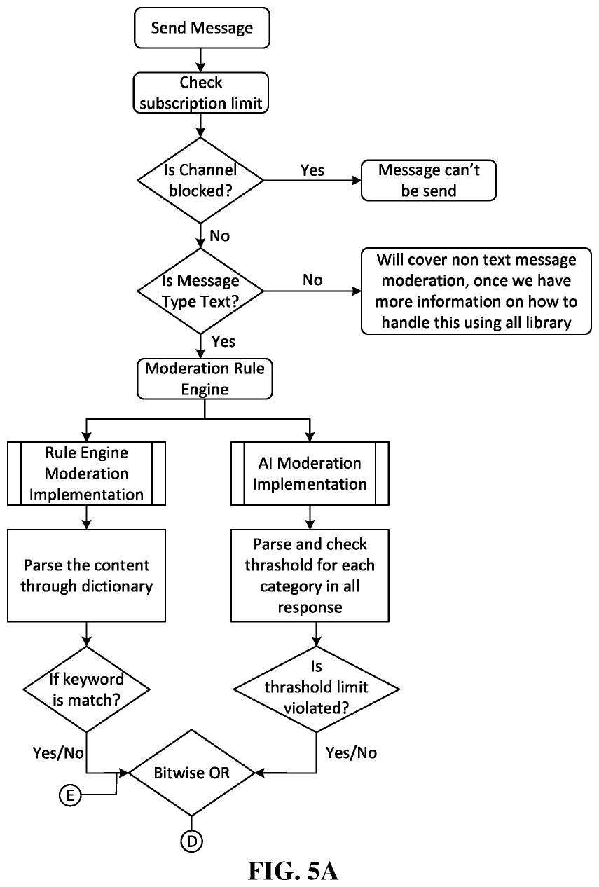

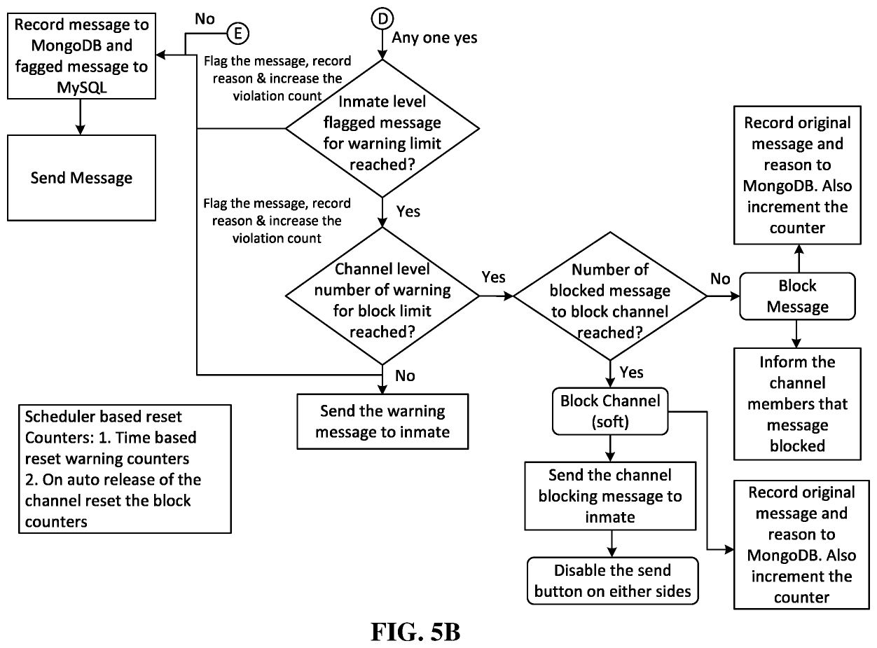

Accordingly, in one aspect, a rules-based system and method are provided for composing, sending, evaluating, and transmitting communications. For instance, as can be seen with respect to FIGS. 5A and 5B, a method for evaluating and sequestering a message for analysis during the transmission process is provided. For example, in a first step, a message is composed and sent. Upon receipt, e.g., by the system server, a first evaluation may be performed, so as to determine the first correspondent's ability to send correspondence, such as to determine whether they have reached their quota of correspondence, or whether they have been restricted from sending correspondence, such as by being prohibited for previous use of restricted words. If they are restricted for some reason, their channel may be blocked by the system and the message will not be sent.

If a restriction is not present, and the channel is not blocked, then the message may be prepared for transmission. However, before the message can be authorized to be sent, a number of analyses may be performed. For example, it may first be determined if the message is a text-based message or not. If the message is a text-based message, upon receipt, the message may be analyzed by an evaluator module of the system, such as one or more moderation and/or rules or models engines, such as an AI moderation engine.

Particularly, when subjected to a rule moderation engine, the message content can be parsed, where each word can be compared to a model or a table or a list, or even a dictionary, or other database architecture of prohibited words, whereby the system can determine, based on the comparison, if a word used in a message matches a word on the prohibited list and further within a prohibited context. In another embodiment, in determining if a violation is present, the message and its content can be subjected to an AI moderation evaluation, such as where the content is parsed and compared against one or more models to determine the likelihood the communication contains prohibited and/or threatening content. In these regards, the communication can be checked against all prohibited content, including all prohibited text-based words and/or image content.

If a match is not determined, the communication may be authorized for being sent. In such an instance, the communication can be transmitted, but a copy of the communication may be stored, such as for further analysis. If a match is suspected, e.g., it is suspected that one or more messages of the communication contains prohibited content, or it is desired to re-evaluate a previously sent communication, one or more messages of the communication can be subjected to further evaluation, such as for various analytical purposes. Particularly, the messaging words and contents can be parsed, classified, and stored, such as within a structured database, such as an intelligent relational structured query language (SQL) database or in a table-based, non-SQL database. The message content can then be compared to one or more models so as to determine if its content, within the context of the overall communication, includes prohibited content. If during the comparison of the actual content of the messages of a communication is determined, e.g., by comparison to one or more models, to include content that violates one or more of the rules of communication platform, then the content and/or message itself may be flagged, a reason for the flagging can be identified, a warning may be issued, and a violation count for the sender can be increased by one.

Where a warning is issued, a warning count number, representing a number of violations for a given user accessing the system, may be increased. If a certain determined number of warnings is passed, then the message composer's ability to send new messages may be curtailed, and in some instances, their channel may be blocked, e.g., where the warning limit is breached. In such an instance, a channel blockage message may be sent to the correspondent and/or to the recipient, and the ability to send messages may be inhibited, such as by deactivating the send button on the dashboard interface of the client application. However, where the limit has not been reached, the message may be blocked, but a mere warning message may be sent, and the warning count may be incremented by one. The channel member, e.g., correspondent, may also be notified that their message was blocked and why. In either instance, the blocked message may be stored in a quarantined database, such as an intelligent relational structured query language (SQL) or non-SQL database, and subjected to additional analysis as described herein.

Accordingly, in various embodiments, the system may include a structured database, which may be coupled to one or more servers of the system and/or one or more client computing devices, such as via a network connection. In various instances, the structured database may include one or more searchable libraries, such as where each library may include data files pertaining to the various different users of the system, such as inmates and their associates, and the correspondences they send. Likewise, the structured database may further be configured to store the data used to train the AI modules, the models and rules employed in performing the disclosed moderations, the instructions directing the various operations of the processing engines disclosed herein, as well as the content being evaluated and the results of those evaluations and how they were achieved.

In these regards, over time, processing resources have become more and more powerful, but also more and more expensive. Data storage resources, however, have become less and less expensive. This is contrary to the expectations of years past, and hence, contrary to the manner in which data has previously been stored, such as in relational databases that employ high processing power to fetch and retrieve results through complex relational structures. Accordingly, although in some implementations, a database of the platform may be an intelligent relational structured query language (SQL) database, in some embodiments, the present database may include a non-relational, single-data database, which may be configured as a Non-Structured Query Language (non-SQL) database.

As described herein, in some instances, there are many benefits for employing a non-SQL, non-relational database. It is cheaper, uses less processing power, and is more efficient, in part, because storage space is less expensive than processing power. However, in other instances, it may also be beneficial for employing a SQL database. Hence, in various embodiments, the communication moderation platform may be associated with one or more of a non-SQL, or with a SQL database, or both, dependent on the use to which the data to be stored is going to be employed.

Particularly, in various embodiments, the communication moderation platform may be coupled to a structured database, whereby the database is specifically designed to be less resource intensive and more efficient. Accordingly, in certain embodiments, the database may be a structured, non-SQL database, whereby, the database is table based, non-relational, and therefore less resource intensive, requiring less processing power for fetching and retrieving data. Thus, fetching and retrieving data in such a non-relational database is much more rapid, and less more resource intensive. In these regards, in particular embodiments, rather than storing data once, in a single relational database, where the data is stored relationally, the present system may employ a multiplicity of databases, where data may be stored in a plurality of locations, based on its relation, where its use model may dictate which databases it will be stored within.

In such a manner, the number of relations for the use of any given data element may dictate the number of databases and/or the number of tables the data will be duplicated in stored within. This makes accessing data easier, and less resource intensive, because many of the data related to a given operation may be stored in the same operations focused database. Particularly, it is more efficient to store data in a database that is centered on its use models, whereby the data useful in performing certain operations is all stored together, non-relationally, but in tables that are used for rapid look ups, where the tables are related one to the other in that they contain the data useful for performing a specified set of operations.

This structured configuration makes lookups quicker because complex data structures are not employed, but rather the data is stored in easily accessible tables, whereby the tables may be related to one another, and where data applies to one or more tables, it is stored in duplicative tables. This increases the storage usage, but decreases the CPU usage. Likewise, not only are lookups faster, the processing resources expended in performing a look up in a table is simple and less CPU/GPU processing intensive, because large data structures do not need to be processed. Thus, this is more efficient, and expends less CPU/GPU consumption. Hence, data may be stored in a plurality of databases, which accommodates better and more efficient fetching and retrieval, where the database into which a given data element is to be stored depends on the purpose for which the data is to be used.

As indicated, this is contrary to the single, large relational databases that are now typically being employed. Rather, in this instance, a large number of databases may be utilized where each database may be specifically designed and structured based on the functionalities to which the data is going to be employed, whereby data may be stored in one extensive table or multiple tables. Consequently, in certain embodiments, some of the databases employed herein may be search-specific databases, where the data retained therein is stored based on how the various processing modules will utilize that data. In this manner, all data to be used in the performance of the operations disclosed herein is stored in a database that may be at least partially dedicated for storing the data that is necessary for performing each given operations in question.

In these regards, data that is related may all be stored in the same table within the same database, so that performing a search for related data will not involve processing a large data structure, but rather will only involve a lookup in a single table. In essence, if a table stores an inmate's information, it may include their known associations, which when searched can be immediately returned, because data gets duplicated in each record. Particularly, a table may be represented as a collection of records, where each record represents an entity. And records are designated by entity type. For instance, each entity has a type, like an Officer type, an inmate type, and the like, and each entity may be defined by one or more properties.

In such an instance, a record could be could include immutable data related to an inmate, such as with regard to their name: first name, last name. In the same table there could be an inmate relation record, which indicates all the inmate's friends, e.g., the friend's first name, the last name, etc., all the immutable data of the friend. Further, in the same table, the friend's record can be included as well, which, record could have the friend's related data like the address, phone number, and the like. This can be repeated for all known associates of the inmate. Thus, all of the immutable data of all of the known or suspected associates of the inmate may be stored collectively in the same table together. Whereas, in a relational database, all of this data may be stored in different files, and a multiplicity of lookups may be required to pull several different records to determine all of the relationships any given person has based on the data structure.

Accordingly, in a table-based, non-SQL database, any data needed to show relationships between entities can be stored in the record of each entity, e.g., in a duplicative manner, and thus may be immediately retrieved, without the need to generate a large data structure. With regard to storing data in multiple databases, this may involve storing mutable data, e.g., data that can change over time, but in such instances, as the data changes, the data within all of the tables in which it is stored will need to be updated. Hence, in some instances, it may be useful to only store immutable data in multiple databases, such as names, birthdates, certain physical characteristics, and the like.

Further, in various embodiments, a time-stream specific database may also be provided where all data (or content specific data) related to a given period of time may be stored, such that data related to time specific events may be rapidly and efficiently retrieved, such as based on time-events. For instance, as indicated, multiple purpose-oriented databases may be implemented, which means there may be a different type of database for different types of operations to be performed based on their operational needs. However, in regards to the time-streaming database, the key factor is an event's relation to time, and thus, in this regard, this form of database may have a relational data structure, because what is wanted to be known is how many and which events happened in a particular amount of time.

For instance, data pertaining to what event happened at what time, such as in this amount of time (in the last year, in the last week, in the last day, last hour, last minute, etc.), may all be stored in this database, e.g., relationally, in a time sensitive manner. In this manner, the database may be queried to return all events of a selected type that happened within a given time range, for instance, how many inmates wrote things that ended up including a violation and had to be sequestered within the last day, week, month, and the like. Or, how many times did a certain event happen within a given time period. Hence, events of import that happens within a given time range may be saved and search, relationally, within the time series database.

Likewise, one or more indexing databases may be provided whereby various classifications and/or categories of data that is commonly used may be rapidly searched and retrieved, on a very quick, fast access configuration. Further, an inverted-index searchable database may also be used, where data may be stored in an inverted, indexed manner that facilitates searching. Accordingly, all data records stored in this database are indexed in a manner that the records can be easily searched and retrieved, e.g., via the index. In this manner, when a search of the database is performed, not only are relevant records returned, but they are returned within an order of relevancy. This database is therefore relational, whereby not only are records returned they are also scaled in relation to one or more relevancy indicators.

In a further aspect, a method of using a client computing device to access the substantially real-time communication platform to send communications back and forth with one or more recipients is provided. In a first series of steps, the method may include using a client computing device to download the client application, create a user account and profile, and set a client password for allowing access to the system. In certain embodiments, a picture may also be uploaded into the system.

In various embodiments, the registration process may be automated so as to walk any particular user through signing up for and accessing the application. In various instances, various populations of potential users of the application may be prepopulated into the application, whereby registration for those within one of those prepopulated populations is simple and may involve engaging with an icon representing that person, such as by clicking on their name or image, entering a predetermined identifier, such as a social security number, tax ID, or other identifier to verify their identity, a variety of security questions may be presented and need to be answered, and once verified the user may then access and begin using the application. In certain instances, a random passcode may be generated for each user, such that by entry of that passcode, access to their profile and use within the system is granted, such a passcode may be received upon request by the user from a system administrator.

For other users, not pre-populated into the system, registration for them may be more detailed requiring following a series of menus or prompts that walk the potential user to enter information regarding their identity, their address, their social history, and a back ground check and/or other verification process may occur so as to set up their access for entering and using the application. Once set up, a verification code can be sent to the user for authenticating their desire to participate within the system. Other “Know Your Client” information can be gathered, and 2-Factor Authentication can be set up for further security.

For instance, in certain instances, in signing up through the application, a potential system user may be required to take a picture of themselves and take a picture of their government ID, such as through a camera interface provided by the application, and then to upload the images into the system via the app. The system itself, or a moderator thereof, may then verify that the person's image matches the image of the person thereby authenticating them and allowing them to access the system platform. A voice signature may also be uploaded in a similar manner, using a voice recording mechanism interface of the application.

In various instances, the system may be configured such that once one person is added to or verified on the system, various other people associated with that person, such as from their family, friends, or social network, e.g., via their FACEBOOK®, INSTAGRAM®, etc., may be automatically populated by the system, such as by manually being added by the users, e.g., their name, phone number, and/or email address, etc., system moderators, or web-crawling their contacts and/or social media platforms. An invite link may be autonomously generated and sent, e.g., via their email or text, to the identified relational parties, whereby they may engage with the invite, accept to participate with the system, and then they may begin corresponding with the first user participant.

Hence, once a user is added, a variety of their known contacts may automatically be populated so communications can easily be initiated, such as by engaging with an icon representing the person with whom the first user would like to communicate, such as by the first user inviting them into a conversation or other interaction, such as by email, instant message, text, and the like. Potential users of the system may be identified via their names, phone numbers, social media designations, and the like. Once an invitee accepts the invitation, they immediately get added to the first users contacts. Likewise, the contacts of the invitee may then be pre-populated in the system, such that clusters of contacts may continually be added in known associations with defined members of the system.

In various instances, upon a user engaging with the application, entering their information, and joining the system, the user may then be added to and presented a list of potential communication recipients, which list may be retained within a database, such as a structured, searchable database that may include one or more libraries of potential communication recipients. In various instances, the libraries containing various lists of communication recipients can be continually updated via a suitably configured application programming interface (API), which allows the system to pull and receive a continual stream of data pertaining to available communication recipients so as to ensure the most up to date list of potential communicators.

In particular instances, the system may actively pull lists from various outside databases with which they are connected via an API, SDK, or other network connection. In other instances, database operators from these outside sources may actively send updated list to the system, such as via the API, SDK, or network connection, on a regular basis, which lists may then be employed to update and populate the various libraries of the system. Additionally, when an updated list is received, and one or more previously listed potential recipients are no longer present on the list, that recipient may be flagged for review and/or be expunged, e.g., automatically, from the library.

The user may then search the list to identify a particular recipient to communicate with, which search can be performed by name, identification number, or other identifier, etc., and can be filtered by geographical region, state, county, city, location, institution, facility, gender, age, or other demographic. For instance, the user's friends and family members, e.g., those who have active accounts, may be auto populated and presented to the user for selection and the beginning of correspondence, while those without active accounts can automatically be invited. For any given potential communication recipient, the user can approve/disapprove their presence on their communication list and/or approve or disapprove messages that were sent to the user from that potential communicator. Particularly, messages can neither be sent nor received until the relevant parties have accepted an invitation and have been authorized to use the system.

Once the desired recipient is located, e.g., by their name or icon, they may be selected, a chat interface may be opened, and a message may be input. In various instances, a plurality of recipients may be selected and a group chat platform may be established. In an exemplary use case, by selecting on a chat recipient a pier-to-pier chat channel is established, an input interface is opened, and the system may enter a message receipt protocol, for preparation of receiving, analyzing, and evaluating a message. In various embodiments, the correspondence interface may also allow for attachment of files, images, voice messages, graphics, gifs, gyphys, video clips, and the like.

Particularly, the client application running on the user's client computing device, or a project builder portion of the instant messaging server communicating therewith, may generate a dashboard interface, e.g., at the display of the client computing device, through which dashboard interface a menu option containing a list of message recipients may be presented. In various embodiments, each correspondent may be represented by a photo or icon, a name, identification number, or other designator. A user wanting to draft a communication may then engage the dashboard interface, and select a recipient to correspond with. For instance, by engaging with the representation of the desired correspondent, e.g., by clicking on their icon or avatar, information pertaining to that potential correspondent may be retrieved from the database and be presented to the user. Likewise, once a recipient has been selected, a communication interface may be generated, a messaging screen for drafting the correspondence may be presented to the user, and a communication may begin to be drafted.

In various embodiments, when crafting or reviewing a correspondence, a communication builder and/or a communication viewer interface may be generated at the display of the first client computing device. In such an instance, a user of the client computing device can either use the communication builder for generating a communication, or use the communication viewer for reviewing and/or assessing a previously drafted communication. Particularly, the communication builder and/or communication viewer may be configured for generating a graphical user interface (GUI) for presentation at the display of the client computing device, such as where the GUI includes an interactive dashboard display into which one or more words may be entered for the purpose of building or reviewing a communication.

In certain instances, the method for crafting a communication may further include generating, at the graphical user interface of the dashboard display, an intuitive client interview including one or more questions or interrogatories that are configured for eliciting one or more responses from the individual using the client computing device. The one or more responses may be used, e.g., by the application or a server associated therewith, to assist in generating the communication. During this process, words proposed to be used that have been prohibited can be flagged, the violation can be explained, and an alternative word usage can be suggested. Likewise, for reviewing and evaluating communications that have already been drafted, one or more communications to be reviewed and evaluated may be populated within the interactive dashboard display, whereby a communication and/or one or more word fragments, words, sentences, and/or images used in the communication can be reviewed to determine if they are related to prohibited content.

Next, with respect to communication generation, the method may include receiving, at the interactive dashboard interface, or an input device associated therewith, the responses and/or content from the individual. These received responses may then be employed to create a personalized communication for the individual. Likewise, with respect to communication review, the dashboard interface may provide tools by which a reviewer can notate word meaning, determine context, and score violations. Once a communication has been crafted and/or reviewed, the communication can further be sent for autonomous AI review and evaluation, if desired, such as for further evaluation and/or model training of one or more AI modules of the system.

The autonomous evaluation of the communication may include a comparison, by an analytics module of the system, of one or more of the word fragments, words, phrases, sentences, paragraphs, and/or images contained in the communication to a database containing prohibited content, whereby the method therefore, may include performing a probability analysis that any of the evaluated content is likely to reference prohibited content. Specifically, the content employed in the communication can be parsed into its independent words, or word fragments and/or phrases, and each of these elements may then be compared to a database containing prohibited content. The prohibited content contained in the database may be embodied in one or more models and/or rules. In evaluating the content used in the communication, the identified content to be reviewed may be used to access one or more searchable libraries, such as of a structured database, so as to identify and retrieve data pertaining to a potential relationship between the content included in the communication to be sent and prohibited content identified in one or more of the searchable libraries.

Accordingly, if a relationship between content of a communication to be sent and prohibited content is identified, such as by comparison with a relevant model and/or rule, then, in a further step, the nature of the relationship may be analyzed, e.g., by a suitably configured analytics module of the system, e.g., an artificial intelligence module. The potential relationship can be evaluated so as to determine a likelihood that the identified content includes prohibited content, and/or poses a threat to one or more individuals. If a violation and/or threat is determined to potentially be present, the nature of that violation or threat may then be characterized. In such instances, in determining the presence of prohibited content and/or a nature of a threat, the analytics module of the system may compare the words used individually, the words used in relation to one another, as well as the phrases that those words represent when combined together, and these elements may then be compared to other instances in a database of instances, e.g., to one or more prohibited use models, whereby such words, word combinations, and/or phrases have been used in the past and a violation and/or threat result actually occurred.

This data may then be used to characterize the presence and nature of a violation and/or threat, and then based on the extent of the relationship that is determined, the probability that the words and phrases, in the present instance, is likely to contain a violation and/or lead to a potential threat can then be determined. And if a determined probability threshold is passed, then the communication can be deemed by the system to contain a violation and/or threat, and in such an instance, the communication can be sequestered and not be transmitted. However, if the threshold is not met, the communication can be transmitted, and if necessary, a warning can be given as to the extent that prohibited content may have been present, but not to a degree as to require sequestration, and/or the communication can be flagged for manual review.

In particular instances, the messaging to be sent may be via direct or text messaging, and in other instances, the messaging may be sent via an email like exchange, but in any instance, the messaging will be collected by the server and evaluated, which evaluation, in various instances, may be near real-time. As indicated, in various embodiments, the system itself may be configured for implementing one or more of the aforementioned method steps, or one or more individuals, such as a first and/or a second individual, may employ an accessible client computing device to perform various of the described method steps. For instance, the computer implemented methods disclosed herein may include a second individual, such as a third-party monitor, accessing, e.g., at a second client computer device, a project viewer, such as where the project viewer is configured for providing a second graphical user interface to the second client computing device, e.g., via a network connection, for display thereby, a second dashboard for presentation via the second display.

In such an instance, the second dashboard interface may be configured for presenting one or more controls to the second individual for the purpose of allowing the second individual to participate in performing one or more tasks in evaluating a communication that has been flagged and/or sequestered and/or to evaluate the communication crafter and/or its recipient, as well as the context of the entire communication and its process. Particularly, in this instance, the system and its method of use may include the second individual utilizing the controls of the second dashboard so as to monitor one or more communications and/or an associated interactive interview that was conducted by the system in an effort of helping the communicator craft the communication.

Next, the method may include evaluating, e.g., by the second individual, e.g., using the client computing device, or by the AI of the system, the received communication and/or responses from the first individual in response to the client interview so as to produce evaluated responses for the first individual with respect to the communication they crafted and intend to transmit. In various instances, the interactive interview may be employed so as to generate a characteristic profile of the communication crafter and/or the intended recipient of the communication. Accordingly, the second individual may then use the dashboard interface to employ the one or more characteristics of the communication crafter and/or the communication recipient so as to better evaluate the level of violation and/or threat content of the crafted communication.

In view of the above, in one aspect the present disclosure is directed to a system for generating and evaluating communications prior to their transmission to an addressed recipient, which in various embodiments, may be based on a determined relationship between words and/or phrases used in a communication to words and/or phrases contained within a data structure of a database of prohibited word and/or phrases. Accordingly, in various embodiments, the system may include a first client computing device for crafting a communication, whereby a system server may interact with the first client computing device so as to generate a graphical user interface at a display of the client computing device. The display may present a dashboard interface through which a first user, e.g., content generator, can enter content for the creation of a communication, and in some instances, may be presented with a client interview for the purpose of helping the communication crafter to craft the communication, and/or to generate a user profile of the first user.

Accordingly, the system may include one or more of a structured-databases, one or more client computing devices, and one or more server systems. For instance, the system for generating and evaluating a communication may include a structured database, such as a structured database that includes one or more searchable libraries, for example, a database wherein at least one library contains data files pertaining to one or more, e.g., a plurality, of words, word fragments, phrases, sentences, and the like, that may be prohibited because they are provocative or at least associated with one or more provocative concepts that are capable of being expressed in language and/or images. This content can be contained within one or more models that have been generated by the system and include examples of prohibited content in prohibited context.

Further, in various embodiments, the system may include a client computing device having a display coupled therewith, such as for displaying a graphical user interface that is generated by one or more of the client computing devices and/or a server associated therewith. For example, in a particular embodiment, a crafted communication can be received by a server of the system and be evaluated thereby, such as by comparing the words, word fragments thereof, and/or phrases associated therewith, and comparing those elements to a database of one or more models having the same or similar elements in a database of restricted or otherwise prohibited word and/or word fragments and/or phrases of concern, which word elements may be evaluated for their potential for provoking a threatening experience and/or response.

Likewise, a user, such as a system administrator may engage a further, e.g., a second, user interface of a further client computing device for the purpose of reviewing content that has been flagged and/or sequestered, such as to review the content and/or to agree with sequestration and/or to a penalty associated therewith, or to over-ride that sequestration and/or recommended penalty. Particularly, the method may include an individual, e.g., system administrator, accessing one or more controls of an interactive dashboard presented at the graphical user interface of the second client computing device so as to participate in the evaluation process, whereby they may review the flagged communication, its content, attachments, the communications crafter's responses to the generation interview, and any further files associated therewith, such as attachments.

For instance, the GUI presented at the display of the system administrator's client computing device may be configured for displaying a flagged communication, the communication containing highlighted word fragments, words, phrases, and the like, which have been identified by the system as bearing some relation to a threatening element. Additionally, a score may be presented with each flagged content element, whereby the score represents a probability of threat level associated with the flagged content, and the results of any content creation interactive interview may also be presented. Once the content has been evaluated by the system administrator, it may be confirmed for sequestering, or it may be approved for being transmitted to the intended recipient.

As indicated, for evaluation purposes, the communications system may include a structured database that includes one or more communication rules and/or models by which a communication may be evaluated. Specifically, the structured database may include one or more of a models library, containing one or more models by which to evaluate communication content and/or may include a rules library containing a variety of rules by which the communication and its contents are to be evaluated. For example, the model and/or rules library may store a multiplicity of models and/or rules which the system may use to autonomously determine if the wording, phrascology, and content to be included in a correspondence that is to be sent from one party using the system to another contains prohibited content.

As described above, the communication platform includes a server system, which server system may be configured for generating a communication builder that may be utilized by the system so as to provide a dashboard user interface to the client computing device, e.g., via a network connection, for local display at a client computing device. As indicated above, in some embodiments, the communication builder may generate the interface by which the user can draft a communication. However, in other embodiment, the dashboard interface may be generated at the client computing device, such as via the client application running on the client computing device. In either instance, where desired, the communication builder may assist in the drafting of a communication, as well as preparing the communication for transmission.

For example, as described above, the communication builder may generate a communication interview for creating the communication, whereby the user may be asked leading questions, such as via a chatbox interactive helper, which is configured for leading the user through a series of questions designed to determine the kind of correspondence to be drafted, so as to better evaluate and/or suggest the content to be included in the communication. For instance, the client interview may include one or more interrogatories that are configured for eliciting one or more responses from the first individual, such as where the one or more responses are used to produce the suggested content for use in generating the communication. Consequently, once the communication has been generated, the client application transmits and/or the system server receives the communication from the interactive dashboard, e.g., via the network connection, e.g., via a suitably configured API or SDK network, and the like.

After the message has been drafted, it may be sent, such as by selecting a send icon, and the message may be transmitted from the application running on the client computing device, e.g., a mobile smart-phone or tablet, and may be received by the system server, where the message can be reviewed by the system, and be approved for transmission to the selected recipient, or be flagged and/or sequestered, such as for automated and/or in person review, e.g., by a system moderator. In various instances, the dashboard interface may allow for correspondence with a multiplicity of recipients, within the same dashboard interface, such as in one or more screens, such as where the dashboard may be divided into a number of screens equal or greater to the number of recipients the user is interacting with.

In particular instances, the transmission of a communication or message from a sender to a recipient may be substantially real-time. However, in other instances the transmission of the communication or message may not be real-time, such as when the system has to review and potentially sequester communications based on their content. For example, the system may include a language management system that is based on a suitably trained language processing module that can rapidly be configured for understanding and interpreting different languages, converting a communication from one language to another, and performing various review tasks in substantially real-time. As described above, the evaluation and review of correspondence may be performed by one or more AI modules of the analytics platform, the efficiency of which may depend on the level and extent of the training of the respective AI modules.

For instance, for the purposes of training the AI modules, as described herein, the system may include a machine learning engine that is configured for training the various different AI modules to be employed in the communications platform. In one instance, the communications platform may include a pre-pass AI module that is configured for performing language management in a manner that can rapidly scan the words of a communication and determine if prohibited content, on its face, is or is not present. This may occur in situations where the pre-pass AI filter the has been extensively trained by machine learning engine. In this regard, an AI module of the system may include an inference engine that has been extensively trained to rapidly apply one or more models to the content of a communication so as to make rapid judgments as to whether that content contains prohibited content and/or prohibited contexts, without undue analysis, and thus, more real-time messaging may be obtained. As indicated, in various instances, the messaging may include texts or images and may include voice messages as well as one or more attachments. Where text messages and/or audio messages are being transmitted, a natural language processing model may be employed. Specifically, where voice messages are being transmitted, the system can first convert them to text-based messages, and then the texts can be run through the natural language processing module of the system

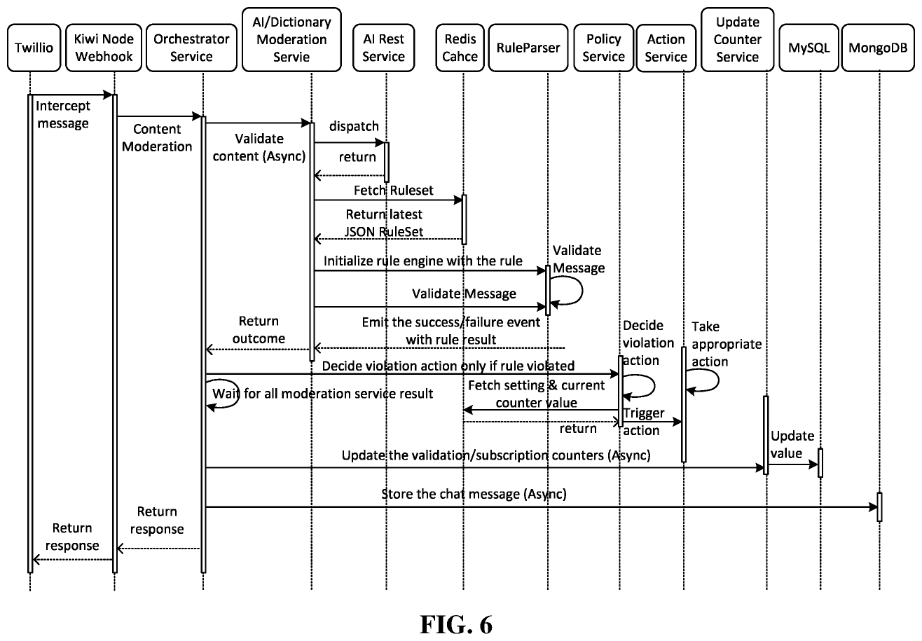

As can be seen with respect to FIG. 6, upon receipt of the message, the communication and any attachments associated therewith can be intercepted and provisionally sequestered for analysis prior to final transmission to the designated recipient. The analytics module may then perform one or more analytics, e.g., content moderation, on the communication components, parse the contents, apply one or more model- or rules-based evaluations of the content parts, weight or re-weight one or more analytic features thereof, and then make a judgement call as to the potential threat level of the communication.

Particularly, once received by the server, the communication, as well as the communication crafter, may be evaluated, such as by an evaluation, e.g., inference, engine of the system. For instance, in certain instances, the communication may be evaluated substantially real-time, e.g., via the communication builder, such as at the time the communication is being generated, or the communication may be evaluated once received from the client computing device, but prior to transmission to the recipient. As indicated, not only may the communication be evaluated, but the communicator themselves may be evaluated, such as based on their history of communication generation and transmission. For example, the communicator may be evaluated based on their word usage and the number of times they have used, or are using, flagged words, such as where the number of times flagged words are used, the less the ranking of the communicator will have, and thus, the greater the scrutiny will be for the communications they craft and send.

Hence, in various instances, the server system may be configured for creating an individualistic characteristic profile for the various parties of the system, such as those drafting evaluating, and receiving messaging content. In such instances, the individualistic characteristic profiles generated by the system may include a characterization of first users who are crafting messages with regard to those with whom they correspond, the length of their messages, how long it takes to draft the message, the frequency of their messaging, as well as its content that has previously been approved and content that has been flagged for being prohibited. Likewise, those who receive and/or reply to this messaging can also be characterized, such as with regard to the number of messages they receive and from whom, the messages to which they respond or do not respond, how long it takes them respond and/or to craft a message, the length of their message, how long it takes them to draft a message, the frequency of their responding or messaging, as well as its content that has previously been approved and content that has been flagged for being prohibited.

Additionally, those who evaluate the messaging and/or the correspondents may also be tracked, such as with regard to the number and type of messages they flag or do not flag, the content flagged or not, as well as the people whom the censor or not. The system may also track how the rules were applied, whether they were followed or over ruled, and/or how the messaging has changed in response to the application of the rules. In these regards, the system may be configured for determining a likelihood that someone will craft prohibited content, or that a threat may be imminent, such as based on an analysis of previous messages sent, content employed and/or flagged, as well as recipients being addressed, and the speed by which they respond, the content they employ, and the number of responses they send, and the like.

Accordingly, the system server is configured for applying the rules regarding prohibited content to the content being crafted or sent, flagging and/or sequestering content that is prohibited, and notifying the crafter or a second party evaluator that prohibited content was produced and/or attempted to be sent, and may further determine and suggest responses to situations where content has been flagged and/or excised one or more times in one or more messages. In such an instance, the response may be dynamically determined based on a level of infringement, such as based on an extent to which prohibited words are used, the type of words used and the level of threat they evoke, the number of times prohibited words are used, the number of times a warning has been given. In such instances, the infringements may result in a variety of different responses that can be applied to the infringer, which response can range in levels of severity, such as from a simple flagging and suggesting of other words that can be used, to a warning that indicates that the prohibited content will be excised from the message, to prohibiting the user from sending the message or the addressee from receiving or sending a message, such as a reply, to preventing the sender or recipient from accessing the platform for a given amount of time, to completely banning them from the platform altogether. Particularly, in determining the likelihood that a message actually contains prohibited content, or predicting whether one or more correspondents may use prohibited content, the system may perform a mapping function whereby one or more words or phrases suspected as being prohibited or containing threatening material are individually mapped to one or more rules so as to define respective relationships there between, whereby each respective relationship may be weighted based on previous known instances having the same or similar relationship with respect to other users employing similar words or phrases in the same, similar, or different contexts.

In various instances, a model generation and/or rule engine moderation test may be performed so as to validate content in a message proposed to be sent. As indicated, and as can be seen with respect to FIG. 6, a library of models and/or a table of rules and/or a dictionary list, may be formulated, such as where examples (e.g., a list) of forbidden words and/or phrases are detailed, or otherwise exemplified, e.g., within a model, along with a designated threat level. Word portions may also be parsed and analyzed for their potential to suggest threatful content. In certain instances, the validation may be performed by the AI platform of the system, where the intercepted message is dispatched to one or more of the AI modules, the message is parsed into its words and/or word parts, such as by a parsing engine. A stored set of models and/or a rule sets, such as from the structured database, is retrieved and is made accessible to the model and/or rules engine, e.g., the inference engine.

The model and/or rules, e.g., inference, engine is then initialized, and the sequestered content is validated by comparing the used words to one or more models and/or a rules list, so as to determine if the message includes prohibited content. For instance, in certain instances, the AI platform may apply one or more of a dictionary moderation protocol and/or a model comparison on the intercepted content. The outcome of the analysis for each word and/or message and/or the communication altogether may be determined based on whether the message includes prohibited content, and if so, a violation may be returned. If no violation is determined, then the message can be passed on to the addressed recipient, but if a rule violation is determined then the message can be prohibited from being sent and it may be stored in a sequestered database, such as for further threat analysis.

In these regards, the system server may include or otherwise be coupled with an artificial intelligence (AI) platform, such as where the AI platform includes a machine learning module as well as an inference engine. For instance, the system may include a machine learning module that is configured for receiving, storing, or otherwise accessing historical data pertaining to how correspondents or evaluators engage the platform, the messages they send or review, the content they use or flag, and the contexts within which they send their correspondence including to whom, where, and when. Using this data a table, knowledge tree, or knowledge graph, or other analytical structure may be generated by which one or more relationships between data points may be defined. These relationships may then be used to make predictions about how messages are being drafted, evaluated, and/or transmitted or sequestered, which predictions can then be employed to modify the composing of messages and/or for determining the potentiality for a threat occurrence. Along with a machine learning module, the system may further include an inference engine, such as where the inference engine may be configured for accessing one or more libraries of the structured database, such as a knowledge structure retained therein, generating one or more models, and determining based on various defined relationships therein, a number of instances of prohibited content use, one or more correspondents engaging in such use, and the potential of a threat because of such use.

For instance, in various instances, the structured database may include a model and/or rules library containing a plurality of models and/or rules, such that a likelihood determination may be made as to when a prohibited word is present and/or when such a presence represents a likelihood of a threat, such as via comparing content used in a communication to one or more models of prohibited content and/or one or more rules defining the same. In such an instance, the likelihood determination may be made by applying at least one of the plurality of models and/or rules to one or more of the one or more flagged and potentially prohibited words, and based on these relationships determining further relationships by which prohibited content may be identified and/or a threat level may be determined.

Further, the inference engine can then determine an appropriate reprobation for known or predicted instances of use of such prohibited content, such as based on a relationship between penalties previously enforced for the same or similar infringements, from the same or similar correspondents, given the same or similar facts and/or contexts as the present instance, whereby for each known instance, a weighting for the respective relationship is increased, where the greater the weighting the greater the likelihood is determined to be. The inference engine can also determine the timing and duration of such penalties, whether they are to be immediate or implemented over time, and can further determine the extent of the response to be evoked by the evaluators, e.g., healthcare workers or guardians, etc., in reaction to the level of warning determined by the system.

Further, where a violation is present, a count recording the number of violations pertaining to the respective correspondent and/or recipient can be incremented, and based on the current count value at that time, a violation penalty may be incurred. For example, based on the violation count a violation action may be triggered where the action may include a warning, such as for a first offense, a more stringent warning, a timeout from messaging, a ban from messaging, or even being de-platformed. Whether a warning is issued or not, a copy of the message may be transferred to one or more of the system libraries for further review and analysis. For instance, where a threat level is determined various data regarding the words, their content, and the parameters of their usage, e.g., their context, including the time they were sent, the type of message and threat category, the level, e.g., severity, of the threat, the sender and recipient's identification, what actions were taken by system in response thereto, and how, when and by what or whom it was reviewed.

The type of content can also be catalogued and detailed, such as if it was a text message, a voice message, an image, an image attachment, an audio attachment, a video attachment, and the like. If the message is allowed between two communicants, the message may be transmitted, and the relationship between them may be strengthened, but, where a mild message warning is designated, the system may allow the transmission but flag the relationship between the two communicants while lowering the weighting between them. Likewise, where the message is designated block, the message may be quarantined, and the sender can be notified of the issue and warned if continued communication content along the same line is sent, further prohibitions may be instituted. If the content is forbidden, the system may sequester the content for immediate review and threat and imminent threat assessment, and may temporarily or permanently suspend the senders and/or recipient's account.

With respect to communication review and analysis, this may be performed autonomously and automatically by the system, e.g., by the analytics system of the communications platform, and/or it may be performed by a system administrator. For instance, as discussed above, in various instances, communications can be sequestered and prepared for manual review, such as on a regular basis, for example, for quality control, training, and/or in situations where the automated computer review is inconclusive. Accordingly, one or more of the aforementioned method steps may be performed by a system administrator charged with overseeing the conditions of one or more environments in a building or facility of buildings.

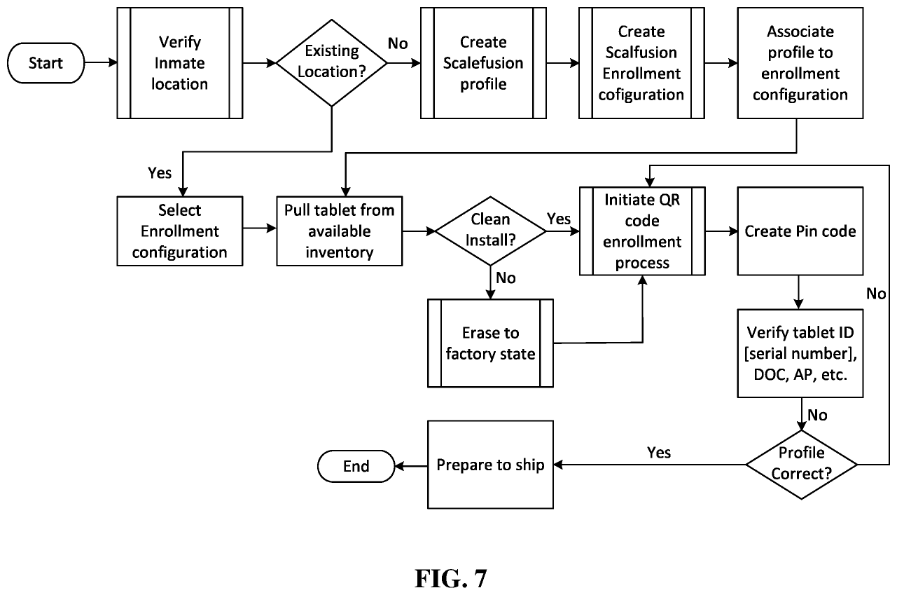

For instance, in various embodiments, provided herein are various methods, having a plurality of method steps, for generating and/or evaluating a communication that may be assessed based on one or more selected criteria and/or characteristics of language, images, phrases, words, and/or word fragments that may potentially be related to threatening content, whereby one or more of the following steps are configured for being implemented by one or more computer and/or servers, such as where the computer implemented method includes one or more of the following steps. To begin with, as can be seen with respect to FIG. 7, a first method is provided where the method may include initially setting up a computing device, e.g., a tablet computing device, that may be delivered to a user, e.g., an inmate, whereby the inmate may be enabled to access the communications system so as to send messages to one or more recipients. For example, in a first step, a proposed inmate user who desires to use a tablet to access the communication system may be verified, validated, and authorized to receive a system tablet.

Particularly, in one embodiment, as can be seen with respect to FIG. 7, a potential user may be authorized so as to receive a tablet computing device by which to access the communications platform. In this regard, prior to provision of the tablet to a new potential user, e.g., inmate, the tablet, or other computing device, can be conditioned and configured. This conditioning may involve reconfiguring the tablet, such as by modifying its initial factory settings so as to add all of the specialized configurations needed for accessing the substantially instant messaging platform, applications, and networking, in such a manner the that tablet can work on the platform when the tablet is delivered to the inmate.

In a first instance, the tablet can be configured to access and communicate with the communication platform being operated at the facility in which the inmate is incarcerated. Accordingly, in order for this to happen the tablet needs to be configured to the appropriate setting of that facility. Consequently, the inmate's facility needs to be identified and located. Once located, the system may reconfigure the tablet settings so that they are consistent with the rules, roles, authorizations, and permissions of the inmate's facility. In various instances, the tablet configurations, with respect to accessing the communications platform via the appropriate access points of the particular facility in which the inmate resides, may be managed by a workflow manager, which may be a mobile device manager system, e.g., “SCALE FUSION”. This mobile device manager system allows the configurations of the tablet computer, e.g., with respect to the communications platform, to be remotely managed. In this regard, the device management system may be configured to remotely access and manage all computing operations, tablet configurations, including the applications available to each agency, facility, and inmate, along with networking configurations, such as the wireless access points that the tablet is granted permission to connect with.

Accordingly, in setting up the tablet for use by a user, e.g., an inmate, a user profile may be generated for each prospective user. User profiles may be used within the system to recognized an individual inmate as well as a group of inmates that are associated by location, e.g., by facility. When creating a user profile, the communications platform may determine what applications, “apps,” are available to be installed on the tablet computing device, e.g., based on facility permissions, along with all Wi-Fi configurations for the facility. Once the tablet is set up and configured, the inmate may be enrolled. The enrollment process may be initiated so as to ensure that this particular inmate is authorized to use the communications platform, and to do so using a tablet computing device.

For instance, an enrollment protocol may be initiated so as to walk the inmate through a more advanced configuration process, which configurations may go beyond the initial set up procedures. This advanced configuration process may include setting up the access points and permissions by which the tablet may be allowed to connect to the communications platforms of the facility within which the inmate is incarcerated. A custom QR code may be generated and used to enroll the inmate and associate that inmate with a particular tablet, and for configuring the table with the appropriate settings of the system. A picture of the inmate and the QR code may be taken, e.g., using the tablet camera, which will associate a particular inmate, with a particular tablet, and with a particular user profile, and may then initiate the enrollment process on the tablet.

Particularly, once the enrollment configuration is selected and initiated, e.g., a particular user becomes associated with both a particular user profile and with a particular tablet for which they are authorized to user. The authorized user and the authorized tablet can then be associated with a particular facility. This step sets the location of any and all tablets enrolled at that facility to the correct application settings, and sets the Wi-Fi access permissions for that particular facility.

Once the tablet is configured with the appropriate facility settings, it can be provided to the inmate. One or more of these steps may be performed by the user, via an automated setup guide, or they may be performed automatically by the system itself. An access pin can then be set up by the user, with which access pin only that user can access the system configurations of that user profile. More, particularly, the final step of the enrollment process may be to create a unique pin code for accessing the tablet. This will be used to unlock the tablet at any time, including the first time it is handed to the inmate. Once all these items are completed, the details will be confirmed to be correct and then the tablet is ready to be shipped out to the designated facility and delivered to the inmate.

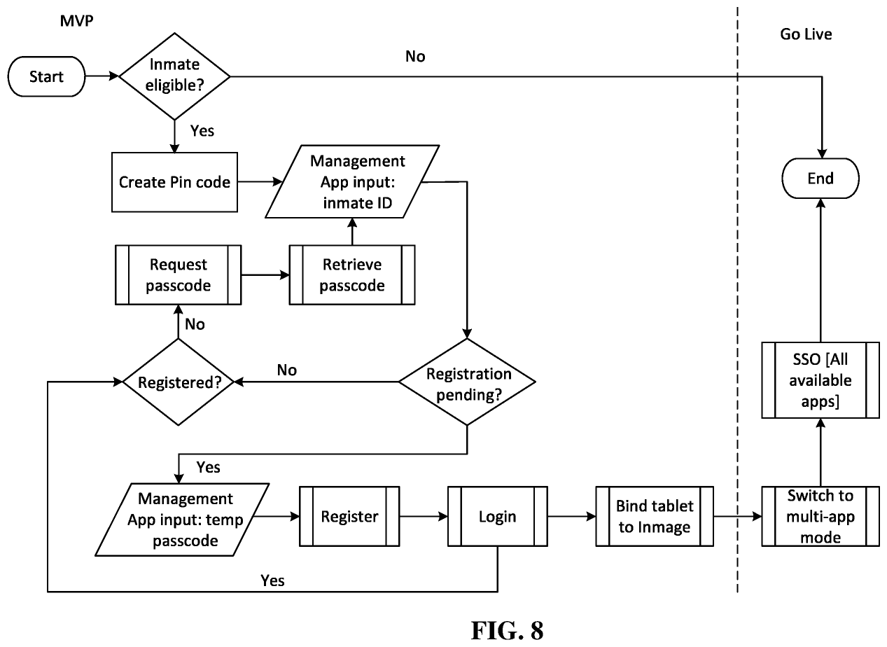

In other embodiments, a potential user may not be authorized to access the communications platform via a tablet computing device, but may be provided access to the communications system via a communications kiosk. In this regard, as can be seen at FIG. 8, the registration process may be performed at a communications kiosk that may be communicably coupled to the communications platform. Consequently, in various embodiments, as set forth in FIG. 8, an inmate seeking to gain access to the communications platform may set up a user profile at the communications kiosk.

Therefore, in a first step, the inmate may access the kiosk and engage the Registration Application, which at this point will be the only application available to the inmate. There will be two options: Register and Log In. Register will need to be selected prior to being granted access to the system. To register, the inmate will then input their details into the system, such as their name, inmate ID, and the like, at which point the system will check and confirm that the inmate does not currently have another account, or has been de-platformed from an earlier account. If they do not have an account, or have not been prohibited from accessing a previous account, they will be issued a temporary password, which may be created, and printed out by the mailroom and handed to the inmate in person. This process assures that only the specific inmate will be able to register their account. Particularly, since their inmate ID is a known number and acts as their username, this will protect their account so that the specified inmate is guaranteed to be the one receiving the temporary password and creating a permanent password.

Returning to the kiosk, the inmate can now login to the system by inputting their inmate ID and the temporary password that has been handed to them. At this point, once the system verifies the temporary password is correct, it will allow the inmate to create their account with permanent credentials. This account set up will include creating a new password, and will be prompted to answer 3 security questions to better protect their account. Once they have reviewed these questions and chosen ‘Register’ their account will be completed and ready to use. This account can be used to: access all accounts available on the kiosk available for messaging, whereby a message may be drafted, the kiosk may also allow the user to add funds to purchase platform products such as Music, Movies, Games, eBooks, and the like.

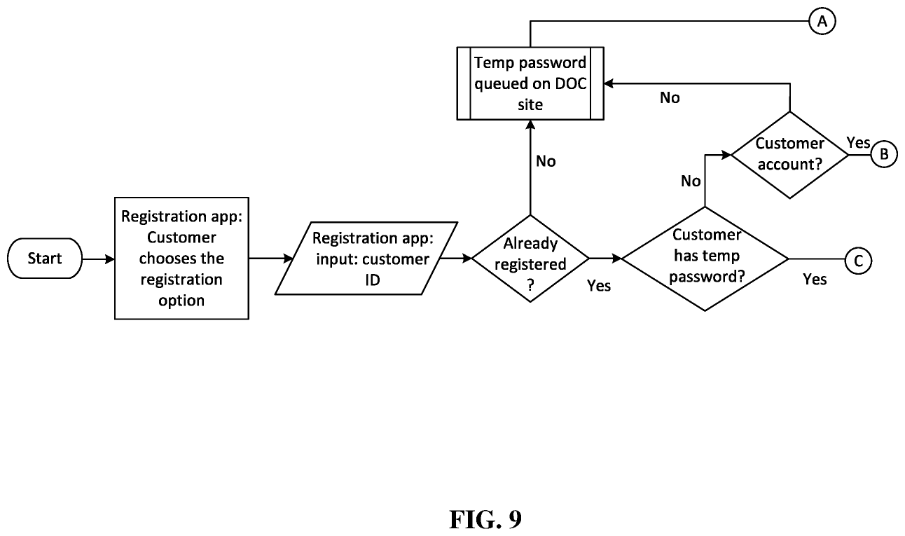

As indicated, in various embodiments, an inmate may qualify for not only using the kiosk to send messages, but they may, as described above, qualify for receiving a tablet by which to access the communications platform. So being, only inmates eligible to receive a tablet will go through the process outlined below. For instance, as can be seen with respect to FIG. 9, there are two ways an inmate can be eligible for receiving a tablet computer. Particularly, the Department of Corrections (DOC), has declared the inmate may be indigent, meaning they have no funds available and/or they are unable to purchase goods from commissary. Or they have placed an order for a tablet, and have no previous prohibitions from accessing the system. Depending on the structure implemented with the DOC, this may be a free option or a paid for option.

Once the tablet has been ordered, and pre-configured, it may be sent and delivered to the inmate. Upon receiving the physical tablet, the user can set up their account, if they have not previously done so by accessing the kiosk, by accessing the account management portion of the client application. Accessing the account management application on the tablet will allow the inmate to complete their tablet enrollment process. When first opening the tablet, this will be the only app available on the tablet to the inmate. By accessing this application, the user can set up their user profile in a manner similar to that described above. This set up will assure that only inmate eligible for a tablet and with an existing account will be handed a tablet and can assign themselves to that tablet.

The enrollment portion of the application will first check that the inmate has registered for an account by verifying their new password. If not, they will then need to go to a kiosk to complete the registration process. This will be available on the tablet in the future. The inmate will then log in to the tablet with their newly created password. At this point the tablet they have signed in on will be bond to that inmate, meaning that this is the only tablet that inmate can use and that tablet can be used by no one else. At this point, the RFID of the tablet may be associated with the inmate for tracking and remote service capabilities. Once the inmate has successfully logged in, the tablet will switch to multi-app mode and will display all available apps to the inmate, examples include the chatting app, dash (DOC communications app), music, entertainment, and education.

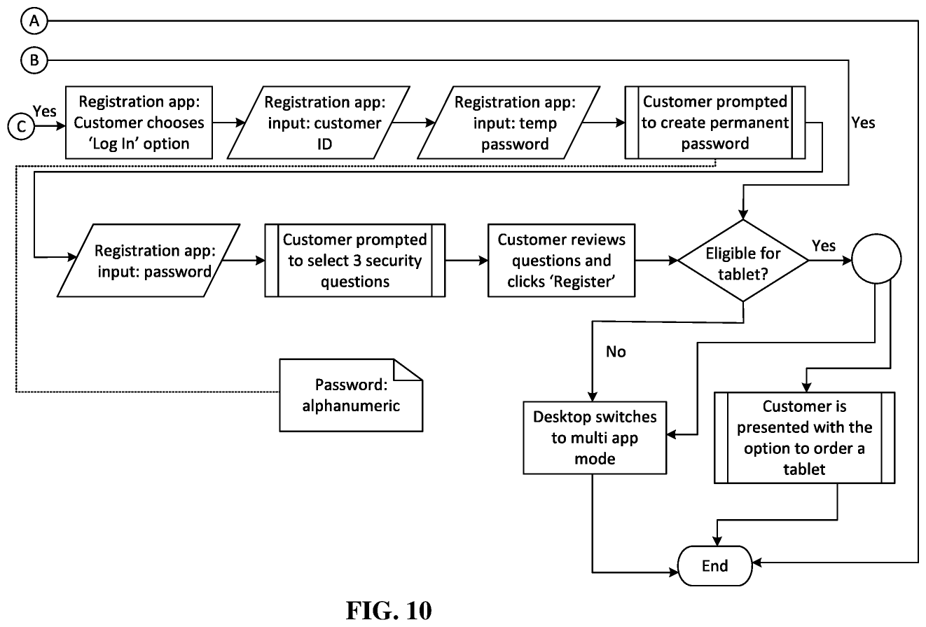

Once enrolled, the inmate may use the tablet to communicate with their friends and family. For instance, as can be seen with respect to FIG. 10, friends and family can access the substantially instant messaging system via the downloadable communication application. Specifically, the friends and family of the inmate may download the Android or iOS version of the chat application from the GooglePlay or Apple Stores. The friends and family will then go through the registration process to create their own accounts associated with and verified by their phone number. As the last step of this registration process, they will need to add an inmate to their account and go into the subscription process outlined below. With this requirement, there will be no friends or family accounts created without an inmate as a contact.

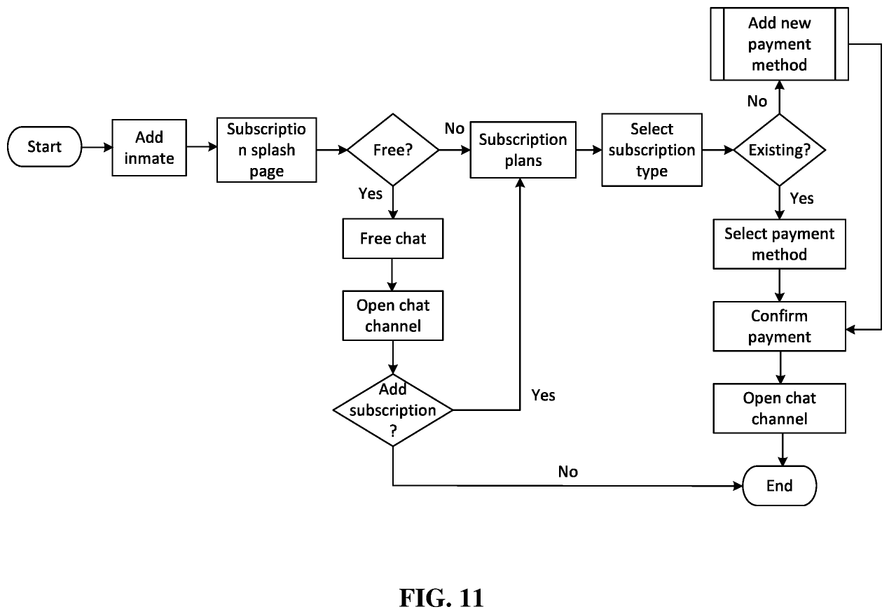

As can be seen with respect to FIG. 11, in registering their account, the friends and family will enter the first and last name or the inmate ID of the inmate they would like to add as a chat contact. After choosing the correct inmate to add, the subscription options will be presented to the user. The friends and family will need to have a subscription, whether free or paid for, for each inmate on their account. If they choose the free chat, they will be taken directly into the chat so they can begin talking with their contact. They can always choose a paid subscription at a later point. If they choose a paid for subscription, they will be taken through the payment process and given instructions on the availability functionality, such as how to send a photo, video or audio note.

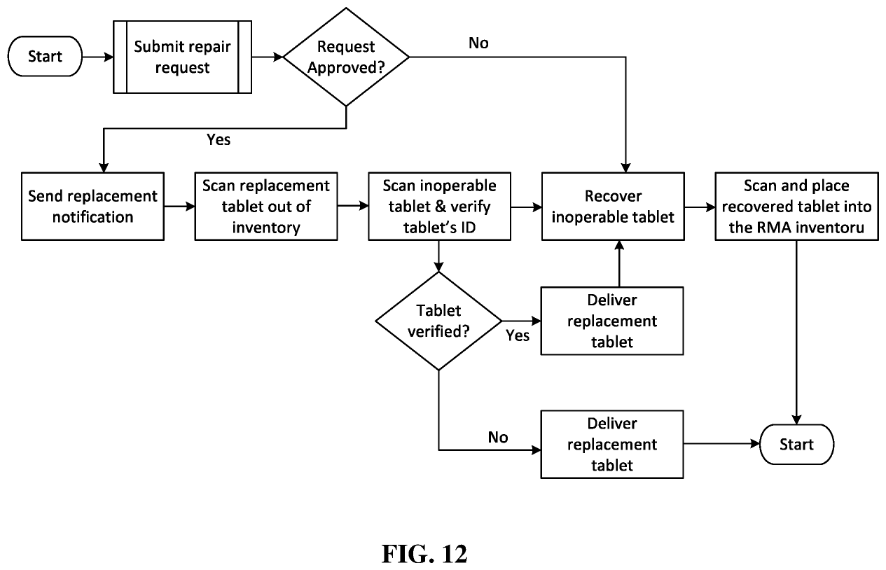

As can be seen with respect to FIG. 12, if a problem occurs with the tablet a repair request can be sent in. If the repair request is denied, the inoperable tablet can be collected. If the request is approved a replacement notice may be sent, a replacement tablet may be checked out, and the inoperable tablet may be scanned, for verification purposes, and can be collected. A replacement tablet can be delivered, the checked out tablet can be returned, and the inoperable tablet can be repaired.

In particular instances, the system may be configured to charge a fee for the messaging, which fee can be set up on a message by message basis, or be based on the amount of data being transferred, or be based on an unlimited amount of messaging but for a specific amount of time, or a mixture of the same. In such instances, a portal may be provided for selecting messaging plans, making payments, and/or upgrading or downgrading such plans. Several different payment options may be provided, such as a free option, e.g., text only once a day to one person, a basic option which allows unlimited text only correspondence to multiple persons with limited attachments, a premium option, which allows unlimited, texts, videos and attachments, and a premium plus option that allows electronic gaming between correspondents. Optionally increased storage may also be provided for purchase. The system may track usage and send reminders to a user such as when they are reaching their usage, data, time, etc. limits, and provide the user the option to increase their limits with an additional payment.

The system may further be configured for tracking and/or scheduling the activities, e.g., daily activities, of the system users. For instance, in certain implementations, the system may be implemented as a downloadable application that can be run on a mobile smart device, such as a mobile phone or smart band or watch, and thus, may be configured for tracking the movements, activities, health, and scheduling events of the various users, and for sending messages between them. For example, a system administrator, or the system analytics themselves, can generate a daily routine for system users, whereby their daily activities may be scheduled, tracked, and various reminders and messages may be sent to the user in advance of the onset of the scheduled activity. In particular embodiments, the system may further be configured for sending messages to individual recipients or to one or more groups of recipients, such as from system administrators, such as for informing them of different time frames within which different activities are to be performed, such as scheduled activities.

For instance, the daily events of the retained individuals may be input into the system, they may be tracked by the system server, and reminders may be sent via the system communications portal so as to remind each individual as to where they are meant to be and when as according to their schedule. Accessing the dashboard interface on a client computing device, the user can access a personalized calendar to see their days, weeks, months-worth of scheduled events. Their to-do activities can be prepopulated into the system, tracked by the system, reminders and notifications can be set up by the individual or the system itself. Likewise, user preferences can also be set up using the dashboard portal.

In various instances, the system may further include an educational portal, whereby the retained individuals may have access to various teaching, training, and recreational platforms. In particular embodiments, the educational portal may be operated on a rewards type basis, whereby the retained individuals earn access to the portal based on their behavior, such as with respect to their compliance with the rules of the establishment. The server, therefore, may control access to the portal, and may assess the individual's eligibility for participating in an educational program, such as via their identification, credentials, and/or qualifications.

For instance, on the server-side, the ID and/or credentials will be verified, program eligibility will be confirmed, and a shadow user account may be created. In determining course assignments, the system may evaluate the credentials and qualifications of the individual user, and may further present the user a list of questions designed to elicit their interests and future goals, and based on this data a number of courses including one or more classes may be assigned to the individual for their participation in the learning program. Hence, in an instance such as this, the individual will not be required, but may choose, to register so when the individual logs in all relevant courses can be pre-assigned. Accordingly, the portal may include access to pre-recorded content as well as live streaming content and/or educational chatrooms, whereby the interested and eligible system user may register for classes, attend class sessions, participate in tutorial or study group chats, and otherwise participate in a remote learning process. Regular online testing and credentialing may also take place via the educational portal. Consequently, the system may be configured for tracking the individual's attendance, participation, and progress through one or more learning modules, and may further notify the participant of what classes they have, when, and what assignments are do for each class, such as via the scheduling module. In person teachings may also take place, and in such an instance, the system schedule can also notify the participant of where the class is being held in person.

For accessing and being assigned assignments as well as for completing assignments, taking quizzes and tests, the individual may access the learning module, through the dashboard interface. Through the dashboard interface the user can also access current active and past courses, as well as see their grades. They will also be able to access present or past course materials, curriculum, assignments, announcements, and the like, and can organize and structure their courses, as well as set up class and personal schedules, or allow the system to do the same. Bookmarks to demarcate progress through the course teachings and reading materials can also be set up, and such progress can be tracked by the system. This allows for quick navigation, such as from a bookmark sidebar ribbon. Navigation between modules can also take place via the dashboard. Where the course is virtual, the user can access the course videos, watch and respond thereto, and can also participate in real-time learning and chats. For instance, through the dashboard interface, the user can access and chat with other students, teacher's assistants, and teachers.

Hence, in various instances, implementations of various aspects of the disclosure may include, but are not limited to: apparatuses, systems, and methods including one or more features as described in detail herein, as well as articles that comprise a tangibly embodied machine-readable medium operable to cause one or more machines (e.g., computers, etc.) to result in operations described herein. Similarly, computer systems are also described that may include one or more processors and/or one or more memories coupled to the one or more processors. Accordingly, computer implemented methods consistent with one or more implementations of the current subject matter can be implemented by one or more data processors residing in a single computing system or multiple computing systems containing multiple computers, such as in a computing or supercomputing bank.

The term “data processor” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

Accordingly, embodiments of the disclosure and all of the functional operations described in this specification can be implemented in digital electronic circuitry, or in computer programming or software, firmware, or hardware, including the structures disclosed in this specification and their structural equivalents, or in combinations of them. Embodiments of the disclosure can be implemented as one or more computer program products, e.g., one or more modules of computer program instructions encoded on a computer-readable medium, e.g., a machine-readable storage device, a machine-readable storage medium, a memory device, or a machine-readable propagated signal, for execution by, or to control the operation of, data processing apparatuses.

A computer program (also referred to as a program, software, an application, a software application, a mobile application, a script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computing systems that are located at one site or distributed across multiple sites and interconnected by a communication network.

Such multiple computing systems can be connected and can exchange data and/or commands or other instructions, or the like, via one or more connections, including but not limited to a connection over a network (e.g. the Internet, a wireless wide area network, a local area network, a wide area network, a wired network, a physical electrical interconnect, an API or SDK, or the like), via a direct connection between one or more of the multiple computing systems, etc. A memory, which can include a computer-readable storage medium, may include, encode, store, or the like one or more programs that cause one or more processors to perform one or more of the operations associated with one or more of the algorithms described herein.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer.

Generally, a processor will receive instructions and data from a read only memory or a random-access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks. Moreover, a computer can be embedded in another device, e.g., a mobile telephone, a personal digital assistant (PDA), a mobile audio player, a Global Positioning System (GPS) receiver, to name just a few.

Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the disclosure can be implemented on a computer having a display device, e.g., a capacitive sensing touch screen device, including a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the disclosure can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back end, middleware, or front-end components. The components of the system can be interconnected by any form or medium of digital data communication, e.g., a communication network. Examples of communication networks include a local area network (“LAN”) and a wide area network (“WAN”), e.g., the Internet. The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object-oriented databases, and for databases having records with complex attribute structures, e.g., object-oriented programming objects or markup language documents. The processes described may be implemented by applications specifically performing archiving and retrieval functions or embedded within other applications.

The methods illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof. It is recognized that various modifications are possible within the scope of the invention claimed. Thus, it should be understood that although the present invention has been specifically disclosed by preferred embodiments and optional features, modification and variation of the invention embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the methods. This includes the generic description of the methods with a proviso or negative limitation removing any subject matter from the genus, regardless of whether or not the excised material is specifically recited herein.

As used herein, unless otherwise stated, the singular forms “a,” “an,” and “the” include plural reference. Although a few embodiments have been described in detail above, other modifications are possible. Other embodiments may be within the scope of the following claims.

That which is claimed is:

1. A computer-automated method of multi-level content monitoring and analysis within an institutional communication network comprising:
deploying first and second mobile computing devices, each mobile computing device running a client application, the client application being configured for allowing messages to be sent from the first to the second client computing device via first being transmitted to a network server for analysis thereby, the network server including an autonomous monitoring module having at least one real-time communication monitor;
deploying, by a communications platform of the autonomous monitoring module, a plurality of real-time communication monitors in the communication network;
detecting, by at least one of the plurality of real-time communication monitors, potential suspicious communication activity based on an analysis of communication flow data selected from one or more of the following categories: communication category, communication type, communication concern, level of communication concern, number of communications being exchanged, identity of communicators, word usage, variance in word usage, infringement, and scale of infringement;
determining, by an analytics platform of the autonomous monitoring module, one or more trends pertaining to the potential suspicious communication activity, the determining including:
collecting past communication flow data including a number of past instances whereby known suspicious communication activity has been determined to include flagged content;
determining a context for each word or word element within the flagged content so as to define one or more trends related to word or word element usage,
generating a model of prohibited contexts based on the one or more trends,
generating a prohibited model library containing a plurality of prohibited contextual models,
selecting, from the prohibited model library, a prohibited contextual model and employing the selected model to compare present communication flow data to one or more of the selected prohibited contextual models from the prohibited model library,
determining if the present communication flow data includes prohibited content,
generating, by the real-time communication monitors, a report of the suspicious communication activity, the report including a result of whether the present communication includes prohibited content, and
automatically updating model by one or more multi-level monitor.

2. The computer-automated method according to claim 1, wherein the analytics module includes a plurality of trained processing engines that are configured for forming a model processing pipeline, wherein each processing engine is trained for performing one or more steps in the determination of the one or more trends pertaining to the potential suspicious communication activity, the trained processing engines comprising:
a first processing engine that is trained for collecting the past communication flow data, the past communication flow data including a number of past instances whereby known suspicious communication activity has been determined to include flagged content;
a second processing engine that is trained for determining the context for each word or word element within the flagged content so as to define the one or more trends related to word or word element usage;
a third processing engine that is trained for generating the model of prohibited contexts based on the one or more trends;
a fourth processing engine that is trained for generating the prohibited model library containing the plurality of prohibited contextual models;
a fifth processing engine that is trained for selecting the prohibited contextual model and employing the selected model to compare present communication flow data to the selected model; and
a sixth processing engine that is trained for determining if the present communication flow data includes prohibited content.

3. The computer-automated method according to claim 2, wherein the prohibited contextual model of the analytics module comprises a language model.

4. The computer-automated method according to claim 3, wherein the comparing of the present communication flow data to the selected prohibited contextual model comprises determining a contextual meaning for each word or word element of the present communication flow data so as to generate a contextual definition for each word or word element.

5. The computer-automated method according to claim 4, wherein the comparing of the present communication flow data to the selected prohibited contextual model further comprises determining a level of correspondence between the contextual definition for each word or word element of the present communication flow data and the selected prohibited contextual model, and weighting the level of correspondence based on the degree of correspondence between each individually contextually defined word or word element and the language model.

6. The computer-automated method according to claim 5, wherein the greater the degree of correspondence between each individually contextually defined word or word element and the language model, the greater weight is placed on each contextually defined word or word element.

7. The computer-automated method according to claim 6, wherein the model is updated based on the present communication flow data, when the weighting is above a determined setpoint.

8. A computer-automated method of multi-level content monitoring and analysis within an institutional communication network comprising:
deploying a first computing device running an application, the application being configured for allowing messages to be sent from the first computing device to a second computing device via first being transmitted to a network server for analysis thereby, the network server including an autonomous monitoring module having at least one real-time communication monitor;
deploying, by a communications platform of the autonomous monitoring module, the at least one real-time communication monitor in the communication network;
detecting, by the at least one real-time communication monitor, potential suspicious communication activity based on an analysis of communication flow data between the first and second computing devices, the suspicious communication activity being selected from one or more of the following categories: communication category, communication type, communication concern, level of communication concern, number of communications being exchanged, identity of communicators, word usage, variance in word usage, infringement, and scale of infringement; and
determining, by an analytics platform of the autonomous monitoring module, one or more trends pertaining to the potential suspicious communication activity, the determining including:
collecting past communication flow data including a number of past instances whereby known suspicious communication activity has been determined to include flagged content;
determining a context for each word or word element within the flagged content so as to define one or more trends related to word or word element usage,
generating a model of prohibited contexts based on the one or more trends, and
comparing the model of prohibited contexts to the present communication flow data, and
determining if the present communication flow data includes prohibited content.

9. The computer-automated method according to claim 1, wherein the analytics module includes a plurality of trained processing engines that are configured for forming a model processing pipeline, wherein each processing engine is trained for performing one or more steps in the determination of the one or more trends pertaining to the potential suspicious communication activity, the trained processing engines comprising:
a first processing engine that is trained for collecting the past communication flow data, the past communication flow data including a number of past instances whereby known suspicious communication activity has been determined to include flagged content;
a second processing engine that is trained for determining the context for each word or word element within the flagged content so as to define the one or more trends related to word or word element usage;
a third processing engine that is trained for generating the model of prohibited contexts based on the one or more trends;
a fourth processing engine that is trained for comparing the model of prohibited contexts to the present communication flow data; and
a sixth processing engine that is trained for determining if the present communication flow data includes prohibited content.

10. The computer-automated method according to claim 9, wherein the prohibited contextual model of the analytics module comprises a language model.

11. The computer-automated method according to claim 10, wherein the comparing of the present communication flow data to the selected prohibited contextual model comprises determining a contextual meaning for each word or word element of the present communication flow data so as to generate a contextual definition for each word or word element.

12. The computer-automated method according to claim 11, wherein the comparing of the present communication flow data to the selected prohibited contextual model further comprises determining a level of correspondence between the contextual definition for each word or word element of the present communication flow data and the selected prohibited contextual model, and weighting the level of correspondence based on the degree of correspondence between each individually contextually defined word or word element and the language model.

13. The computer-automated method according to claim 12, wherein the greater the degree of correspondence between each individually contextually defined word or word element and the language model, the greater weight is placed on each contextually defined word or word element.

14. The computer-automated method according to claim 13, further comprising updating the model of prohibited contexts, based on the present communication flow data, when the weighting is above a determined setpoint.

15. A computer-automated system for generating a model processing pipeline for use in identifying potential suspicious communication activity, the model processing pipeline including a set of trained processing engines, each processing engine being trained for performing one or more steps in the determination of one or more trends pertaining to identifying potential suspicious communication activity, the trained processing engines comprising:
a first processing engine that is trained for collecting past communication flow data, the past communication flow data including a number of past instances whereby known suspicious communication activity has been identified and determined to include flagged content;
a second processing engine that is trained for determining a context for each word or word element within the flagged content so as to define the one or more trends pertaining to identifying potential suspicious communication activity, at least one of the one or more trends being related to flagged word or word element usage;
a third processing engine that is trained for generating a model of prohibited contexts based on the one or more trends;
a fourth processing engine that is trained for comparing the prohibited contextual model to present communication flow data so as to generate potential prohibited communication result data; and
a sixth processing engine that is trained for analyzing the potential prohibited communication result data and thereby determining if the present communication flow data includes prohibited content.

16. The computer-automated system according to claim 15, wherein the prohibited contextual model comprises a language model.

17. The computer-automated system according to claim 16, wherein the comparing of the present communication flow data to the generated prohibited contextual model comprises determining a contextual meaning for each word or word element of the present communication flow data so as to generate a contextual definition for each word or word element.

18. The computer-automated system according to claim 17, wherein the comparing of the present communication flow data to the generated prohibited contextual model further comprises determining a level of correspondence between the contextual definition for each word or word element of the present communication flow data and the generated prohibited contextual model, and employing an additional processing engine to weight the level of correspondence based on the degree of correspondence between each individually contextually defined word or word element and the language model.

19. The computer-automated system according to claim 18, wherein the greater the degree of correspondence between each individually contextually defined word or word element and the language model, the greater weight is placed on each contextually defined word or word element.

20. The computer-automated system according to claim 19, further comprising a further processing engine configured for updating the generated prohibited contextual model based on the present communication flow data, when the weighting is above a determined setpoint.
